(19) United States
(12) Patent Application Publication
(10) Pub. No.: US 2026/0088858 A1
(43) Pub. Date: Mar. 26, 2026

(54) RADIO FREQUENCY EXPOSURE COMPLIANCE USING IMBALANCED MULTIPLE-INPUT, MULTIPLE-OUTPUT TRANSMIT POWER LIMITS

(71) Applicant: QUALCOMM Incorporated, San Diego, CA (US)

(72) Inventors: Jagadish NADAKUDUTI, Bermuda Dunes, CA (US); Lin LU, San Diego, CA (US)

(21) Appl. No.: 18/896,602

(22) Filed: Sep. 25, 2024

(51) Int. Cl. H04B 7/0426

(52) U.S. Cl. CPC H04B 7/0426

(57) ABSTRACT

Techniques and apparatus for radio frequency (RF) exposure compliance for multiple-input, multiple-output (MIMO) transmissions are described. An example method that may be performed by a wireless device includes determining a respective multiple-input, multiple-output (MIMO) transmit power limit for each of a plurality of antennas of the wireless device. A signal associated with a MIMO transmission is transmitted from each antenna at a respective first transmission power level based on the respective MIMO transmit power limit for the antenna in compliance with a radio frequency (RF) exposure limit. The first transmission power level used for a first antenna of the plurality of antennas is different from the first transmission power level used for a second antenna of the plurality of antennas.

### INTRODUCTION

### Field of the Disclosure

Aspects of the present disclosure relate to wireless communications, and more particularly, to radio frequency (RF) exposure compliance.

### DESCRIPTION OF RELATED ART

Wireless communication systems are widely deployed to provide various telecommunication services such as telephony, video, data, messaging, broadcasts, etc. Modern wireless communication devices (such as cellular telephones) are generally mandated to meet radio frequency (RF) exposure limits set by certain governments and international standards and regulations. To ensure compliance with the standards, such devices currently undergo an extensive certification process prior to being shipped to market. To ensure that a wireless communication device complies with an RF exposure limit, techniques have been developed to enable the wireless communication device to assess RF exposure from the wireless communication device and adjust the transmission power of the wireless communication device accordingly to comply with the RF exposure limit.

### SUMMARY

The systems, methods, and devices of the disclosure each have several aspects, no single one of which is solely responsible for its desirable attributes. Without limiting the scope of this disclosure as expressed by the claims that follow, some features will now be discussed briefly. After considering this discussion, and particularly after reading the section entitled “Detailed Description,” one will understand how the features of this disclosure provide advantages that include improved wireless communication performance.

Certain aspects of the subject matter described in this disclosure can be implemented in a method for wireless communication. The method generally includes determining a respective multiple-input, multiple-output (MIMO) transmit power limit for each of a plurality of antennas of the wireless device. The method also includes transmitting, from each antenna, a signal associated with a MIMO transmission at a respective first transmission power level based on the respective MIMO transmit power limit for the antenna in compliance with a radio frequency (RF) exposure limit, wherein the first transmission power level used for a first antenna of the plurality of antennas is different from the first transmission power level used for a second antenna of the plurality of antennas.

Certain aspects of the subject matter described in this disclosure can be implemented in an apparatus for wireless communication. The apparatus includes one or more memories collectively storing computer-executable instructions, and one or more processors coupled to the one or more memories. The one or more processors are collectively configured to execute the computer-executable instructions to cause the apparatus to perform an operation. The operation includes determining a respective multiple-input, multiple-output (MIMO) transmit power limit for each of a plurality of antennas of the apparatus. The operation also includes transmitting, from each antenna, a signal associated with a MIMO transmission at a respective first transmission power level based on the respective MIMO transmit power limit for the antenna in compliance with a radio frequency (RF) exposure limit, wherein the first transmission power level used for a first antenna of the plurality of antennas is different from the first transmission power level used for a second antenna of the plurality of antennas.

Certain aspects of the subject matter described in this disclosure can be implemented in an apparatus for wireless communication. The apparatus generally includes means for determining a respective multiple-input, multiple-output (MIMO) transmit power limit for each of a plurality of antennas of the apparatus. The apparatus also includes means for transmitting, from each antenna, a signal associated with a MIMO transmission at a respective first transmission power level based on the respective MIMO transmit power limit for the antenna in compliance with a radio frequency (RF) exposure limit, wherein the first transmission power level used for a first antenna of the plurality of antennas is different from the first transmission power level used for a second antenna of the plurality of antennas.

Certain aspects of the subject matter described in this disclosure can be implemented in a computer-readable medium. The computer-readable medium has instructions stored thereon, which when executed by one or more processors, cause the one or more processors to perform an operation. The operation generally includes determining a respective multiple-input, multiple-output (MIMO) transmit power limit for each of a plurality of antennas of a wireless device. The operation also includes transmitting, from each antenna, a signal associated with a MIMO transmission at a respective first transmission power level based on the respective MIMO transmit power limit for the antenna in compliance with a radio frequency (RF) exposure limit, wherein the first transmission power level used for a first antenna of the plurality of antennas is different from the first transmission power level used for a second antenna of the plurality of antennas.

Certain aspects of the subject matter described in this disclosure can be implemented in a method for wireless communication. The method generally includes determining, for a multiple-input, multiple-output (MIMO) configuration of a plurality of antennas, a respective MIMO transmit power limit for each of the plurality of antennas, such that a respective radio frequency (RF) exposure level for each of the plurality of antennas used in a MIMO transmission is in compliance with a radio frequency (RF) exposure limit and respective transmission power levels used for at least two of the plurality of antennas in the MIMO transmission are unequal. The method also includes storing indications of the MIMO transmit power limits.

Certain aspects of the subject matter described in this disclosure can be implemented in an apparatus for wireless communication. The apparatus includes one or more memories collectively storing computer-executable instructions, and one or more processors coupled to the one or more memories. The one or more processors are collectively configured to execute the computer-executable instructions to cause the apparatus to perform an operation. The operation includes determining, for a multiple-input, multiple-output (MIMO) configuration of a plurality of antennas, a respective MIMO transmit power limit for each of the plurality of antennas, such that a respective radio frequency (RF) exposure level for each of the plurality of antennas used in a MIMO transmission is in compliance with a radio frequency (RF) exposure limit and respective transmission power levels used for at least two of the plurality of antennas in the MIMO transmission are unequal. The operation also includes storing indications of the MIMO transmit power limits.

Certain aspects of the subject matter described in this disclosure can be implemented in an apparatus for wireless communication. The apparatus generally includes means for determining, for a multiple-input, multiple-output (MIMO) configuration of a plurality of antennas, a respective MIMO transmit power limit for each of the plurality of antennas, such that a respective radio frequency (RF) exposure level for each of the plurality of antennas used in a MIMO transmission is in compliance with a radio frequency (RF) exposure limit and respective transmission power levels used for at least two of the plurality of antennas in the MIMO transmission are unequal. The apparatus also includes means for storing indications of the MIMO transmit power limits.

Certain aspects of the subject matter described in this disclosure can be implemented in a computer-readable medium. The computer-readable medium has instructions stored thereon, which when executed by one or more processors, cause the one or more processors to perform an operation. The operation includes determining, for a multiple-input, multiple-output (MIMO) configuration of a plurality of antennas, a respective MIMO transmit power limit for each of the plurality of antennas, such that a respective radio frequency (RF) exposure level for each of the plurality of antennas used in a MIMO transmission is in compliance with a radio frequency (RF) exposure limit and respective transmission power levels used for at least two of the plurality of antennas in the MIMO transmission are unequal. The operation also includes storing indications of the MIMO transmit power limits.

Other aspects provide: an apparatus operable, configured, or otherwise adapted to perform any one or more of the aforementioned methods and/or those described elsewhere herein; a non-transitory, computer-readable medium comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example wireless communication system exhibiting radio frequency (RF) exposure to a human, in accordance with certain aspects of the present disclosure.

FIG. 2 is a block diagram conceptually illustrating a design of an example wireless communication device communicating with another device, in accordance with certain aspects of the present disclosure.

FIG. 3 is a graph illustrating examples of transmit powers over time in compliance with an RF exposure limit, in accordance with certain aspects of the present disclosure.

FIG. 4 is a diagram illustrating an example system for measuring RF exposure values, in accordance with certain aspects of the present disclosure.

FIG. 5 is a flow diagram illustrating example operations for managing a time-averaged RF exposure evaluation, in accordance with certain aspects of the present disclosure.

FIG. 6 is a flow diagram illustrating example operations for determining imbalanced multiple-input, multiple-output (MIMO) transmit power limits, in accordance with certain aspects of the present disclosure.

FIG. 7 is another flow diagram illustrating example operations for determining imbalanced MIMO transmit power limits, in accordance with certain aspects of the present disclosure.

FIG. 8 is a flow diagram illustrating example operations for wireless communication by a wireless device, in accordance with certain aspects of the present disclosure.

FIG. 9 is a flow diagram illustrating example operations for wireless communication by a wireless device, in accordance with certain aspects of the present disclosure.

FIG. 10 illustrates a communications device (e.g., a user equipment (UE)) that may include various components configured to perform operations for the techniques disclosed herein, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer-readable mediums for radio frequency (RF) exposure compliance for multiple-input, multiple-output (MIMO) transmissions.

In certain cases, a regulatory agency (e.g., the Federal Communications Commission (FCC) for the United States or the Innovation, Science and Economic Development Canada (ISED) for Canada) and/or a standards organization (e.g., the International Commission on Non-Ionizing Radiation Protection (ICNIRP)) may specify a time-averaged RF exposure limit in order to ensure safe levels of RF exposure as further described herein. In such cases, a wireless device may evaluate RF exposure compliance using a time-averaged operation. For example, the wireless device may perform an RF exposure assessment of past RF exposure over a given time window (e.g., time-averaging window) to determine a transmit power (e.g., maximum allowable transmit power) for a future time interval in the time window that is in compliance with the RF exposure limit (e.g., time-averaged RF exposure limit) for a given transmit scenario associated with the wireless device. As discussed further below, a transmit scenario may correspond to various combinations of radios, communication technologies (e.g., RATs), antennas, antenna groupings, antenna configurations (or beams) (e.g., transmit beam configuration), operating conditions, frequency bands, RF exposure scenarios (e.g., head exposure, body-worn exposure, extremity (hand) exposure, and/or hotspot exposure), device use-case scenarios (e.g., based on active applications on the device, such as voice vs. data applications, gaming vs. video-call applications active on the device), and/or geographical locations or regions (e.g., countries or regions), as illustrative, non-limiting examples.

In certain cases, RF exposure compliance testing may be performed for one or more transmit scenarios supported by the wireless device. The RF exposure compliance testing may involve determining RF exposure and corresponding transmit power limits (e.g., maximum allowable transmit powers) for each respective transmit scenario supported by the wireless device. The transmit power limits for each transmit scenario may be stored and accessed by the wireless device when performing a time-averaging operation.

For transmit scenarios involving MIMO transmission with multiple antennas, current RF exposure compliance testing generally determines a balanced MIMO transmit power limit to be used for antennas involved in the MIMO transmission. As used herein, a balanced MIMO transmit power limit may refer to a same transmit power limit for each of the antennas involved in the MIMO transmission, such that each antenna transmits at a same transmission power level during the MIMO transmission in compliance with an RF exposure limit.

A balanced MIMO transmit power limit is generally determined in part on the maximum value (e.g., largest RF exposure value) in the MIMO RF exposure distribution for the antennas when each antenna transmits at a same transmission power during the MIMO transmission. If multiple antennas are spatially apart, the RF exposure distribution for the antennas may result in multiple hotspots, where each hotspot is closer to each antenna's physical location. In certain cases, however, the amplitudes of the multiple hotspots may not be the same. In such cases, the dominant hotspot (e.g., largest RF exposure value) among the multiple hotspots is generally considered in determining the overall balanced MIMO transmit power limit, thereby, disadvantageng one or more other antennas that have non-dominant hotspot exposures (e.g., lower exposures). In other words, one or more of these other antennas could have potentially transmitted at a higher transmission power than the antenna with the dominant hotspot. Accordingly, one potential drawback to performing MIMO transmission based on a balanced MIMO transmit power limit is that the balanced MIMO transmit power limit can impact the performance of the wireless device in terms of reduced throughput, increased latency, and/or lower transmission range, as illustrative examples.

Aspects of the present disclosure provide apparatus and methods for RF exposure compliance based at least in part on imbalanced MIMO transmit power limits. As described in greater detail below, certain aspects provide techniques for determining a respective MIMO transmit power limit for each antenna such that the RF exposure hotspot associated with each antenna is in compliance with an RF exposure limit (e.g., time-averaged RF exposure limit) and at least two transmit powers for at least two antennas involved in the MIMO transmission are different. Additionally, certain aspects provide techniques for performing a MIMO transmission with multiple antennas, based at least in part on the imbalanced MIMO transmit power limits.

The apparatus and methods for RF exposure compliance based at least in part on imbalanced MIMO transmit power limits described herein may provide various advantages. For example, enabling multiple MIMO antennas to transmit at different transmission power levels during a MIMO transmission may improve the performance of the wireless device in terms of increased throughput, reduced latency, and/or increased transmission range, as illustrative, non-limiting examples.

The following description provides examples of RF exposure compliance, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a channel, a tone, a subband, etc. Each frequency may support a single RAT in a given geographic area in order to avoid interference between wireless networks of different RATs, or may support multiple RATs.

As used herein, a radio may refer to a physical or logical transmission path associated with one or more frequency bands (carriers, channels, bandwidths, subdivisions thereof, etc.), transmitters (or transceivers), and/or RATs (e.g., wireless wide area network (WWAN), wireless local area network (WLAN), short-range communications (e.g., Bluetooth), non-terrestrial communications, device-to-device (D2D) communications, vehicle-to-everything (V2X) communications, etc.) used for wireless communications. For example, for uplink carrier aggregation (or multi-connectivity) in WWAN, each of the active component carriers used for wireless communications may be treated as a separate radio. Similarly, multi-band transmissions for IEEE 802.11 may be treated as separate radios for each frequency band (e.g., 2.4 gigahertz (GHz), 5 GHZ, and/or 6 GHZ). In some examples, a radio is defined based on a RAT and/or frequency for the purposes of RF exposure determination and/or RF exposure compliance.

The techniques described herein may be used for various wireless networks and radio technologies. While aspects may be described herein using terminology commonly associated with 3G, 4G, and/or 5G (e.g., 5G New Radio (NR)) wireless technologies, aspects of the present disclosure can be applied in other generation-based communication systems and/or to wireless technologies such as IEEE 802.11, 802.15, etc.

Although the terms “first,” “second,” “third,” etc., may be used herein to describe various devices, elements, components, regions, layers and/or sections, these devices, elements, components, regions, layers and/or sections should not be limited by these terms. These terms may be only used to distinguish one device, element, component, region, layer or section from another device, element, component, region, layer, or section. Terms such as “first,” “second,” and other numerical terms, when used herein, do not imply a sequence or order unless clearly indicated by the context. Thus, a first device, element, component, region, layer, or section discussed herein could be termed a second device, element, component, region, layer, or section without departing from the scope of the present disclosure.

While aspects described herein refer to two-dimensional (2D) distributions, it will be understood that the described operations and configurations may also be applied to three-dimensional (3D) maps or distributions.

### Example Wireless Communication Network and Devices

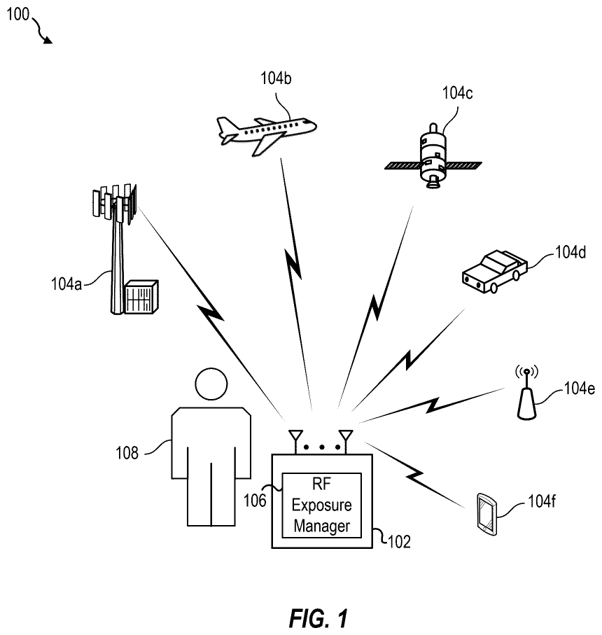

FIG. 1 illustrates an example wireless communication system 100 in which aspects of the present disclosure may be performed. For example, the wireless communication system 100 may include a WWAN and/or a WLAN. For example, a WWAN may include a New Radio (NR) system (e.g., a Fifth Generation (5G) NR network), an Evolved Universal Terrestrial Radio Access (E-UTRA) system (e.g., a Fourth Generation (4G) network), a Universal Mobile Telecommunications System (UMTS) (e.g., a Second Generation (2G)/Third Generation (3G) network), a code division multiple access (CDMA) system (e.g., a 2G/3G network), any future WWAN system, or any combination thereof. A WLAN may include a wireless network configured for communications according to an IEEE standard such as one or more of the 802.11 standards, etc. In some cases, the wireless communication system 100 may include a D2D communications network or a short-range communications system, such as Bluetooth communications.

As illustrated in FIG. 1, the wireless communication system 100 may include a wireless device 102 communicating with any of various wireless devices 104a-104f (a wireless device 104) via any of various radio access technologies (RATs), where a wireless device may refer to a wireless communication device. The RATs may include, for example, WWAN communications (e.g., E-UTRA and/or 5G NR), WLAN communications (e.g., IEEE 802.11), vehicle-to-everything (V2X) communications, non-terrestrial network (NTN) communications, short-range communications (e.g., Bluetooth), etc.

The wireless device 102 may be emitting RF signals in proximity to a human 108, who may be the user of the wireless device 102 and/or a bystander. As an example, the wireless device 102 may be held in the hand of the human 108 and/or positioned against or near the head of the human 108. In certain cases, the wireless device 102 may be positioned in a pocket or bag of the human 108. In some cases, the wireless device 102 may positioned proximate to the human 108 as a mobile hotspot. To ensure the human 108 is not overexposed to RF emissions from the wireless device 102, the wireless device 102 may control the transmit power associated with the RF signals in accordance with an RF exposure limit, as further described herein, where the RF exposure limit may depend on the corresponding exposure scenario (e.g., head exposure, hand (extremity) exposure, body (body-worn) exposure, hotspot exposure, etc.).

The wireless device 102 may include any of various wireless communication devices including a user equipment (UE), a wireless station, an access point, a customer-premises equipment (CPE), etc. In certain aspects, the wireless device 102 includes an RF exposure manager 106 that manages the RF exposure associated with one or more radios in compliance with an RF exposure limit, in accordance with aspects of the present disclosure. The RF exposure manager 106 may determine multiple imbalanced MIMO transmit power limits for multiple antennas associated with a MIMO transmission, and perform a time-averaged RF exposure evaluation based at least in part on the imbalanced MIMO transmit power limits, as described further herein.

The wireless devices 104a-104f may include, for example, a base station 104a, an aircraft 104b, a satellite 104c, a vehicle 104d, an access point 104c, and/or a UE 104f. Further, the wireless communication system 100 may include terrestrial aspects, such as ground-based network entities (e.g., the base station 104a and/or access point 104c), and/or non-terrestrial aspects, such as the aircraft 104b and the satellite 104c, which may include network entities on-board (e.g., one or more base stations) capable of communicating with other network elements (e.g., terrestrial base stations) and/or user equipment.

The base station 104a may generally include: a NodeB (NB), enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. The base station 104a may provide communications coverage for a respective geographic coverage area, which may sometimes be referred to as a cell, and which may overlap in some cases (e.g., a small cell may have a coverage area that overlaps the coverage area of a macro cell). A base station may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

The wireless device 102 and/or the UE 104f may generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always-on (AON) devices, edge processing devices, or other similar devices. A UE may also be referred to more generally as a mobile device, a wireless device, a wireless communications device, a station (STA), a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and other terms.

In certain cases, the wireless device 102 may control the transmit power used to emit RF signals in compliance with an RF exposure limit. RF exposure may be expressed in terms of a specific absorption rate (SAR), which measures energy absorption by human tissue per unit mass and may have units of watts per kilogram (W/kg). RF exposure may also be expressed in terms of power density (PD), which measures energy absorption per unit area and may have units of milliwatts per square centimeter (mW/cm²). In certain cases, a maximum permissible exposure (MPE) limit in terms of PD may be imposed for wireless communication devices using transmission frequencies above 6 GHz. Frequency bands of 24 GHz to 71 GHz are sometimes referred to as a “millimeter wave” (“mmW” or “mmWave”). The MPE limit is a regulatory metric for exposure based on area, e.g., an energy density limit defined as a number, X, watts per square meter (W/m²) averaged over a defined area and time-averaged over a frequency-dependent time window in order to prevent a human exposure hazard represented by a tissue temperature change. Certain RF exposure limits may be specified based on a maximum RF exposure metric (e.g., SAR or PD) averaged over a specified time window (e.g., 100 or 360 seconds for sub-6 GHz frequency bands or 2 seconds for 60 GHz bands).

SAR may be used to assess RF exposure for transmission frequencies less than 6 GHz, which cover wireless communication technologies such as 2G/3G (e.g., CDMA), 4G (e.g., E-UTRA), 5G (e.g., NR in sub-6 GHz bands), IEEE 802.11 (e.g., a/b/g/n/ac), etc. PD may be used to assess RF exposure for transmission frequencies higher than 6 GHz, which cover wireless communication technologies such as IEEE 802.11ad, 802.11ay, 5G in mmWave bands, etc. Thus, different metrics may be used to assess RF exposure for different wireless communication technologies.

A wireless device (e.g., the wireless device 102) may be capable of transmitting signals using multiple wireless communication technologies and/or frequency bands, and in some cases, capable of simultaneous transmission of such signals. For example, the wireless device may transmit signals using a first wireless communication technology operating at or below 6 GHZ (e.g., 3G, 4G, 5G, 802.11a/b/g/n/ac, etc.) and a second wireless communication technology operating above 6 GHz (e.g., mm Wave 5G in 24 to 60 GHz bands, IEEE 802.11ad or 802.11ay). In certain aspects, the wireless device may transmit signals using the first wireless communication technology (e.g., 3G, 4G, 5G in sub-6 GHz bands, IEEE 802.11ac, etc.) in which RF exposure may be measured in terms of SAR, and the second wireless communication technology (e.g., 5G in 24 to 71 GHz bands, IEEE 802.11ad, 802.11ay, etc.) in which RF exposure may be measured in terms of PD. As used herein, sub-6 GHz bands may include frequency bands of 300 megahertz (MHz) to 6,000 MHz in some examples, and may include bands in the 6,000 MHz and/or 7,000 MHz range in some examples.

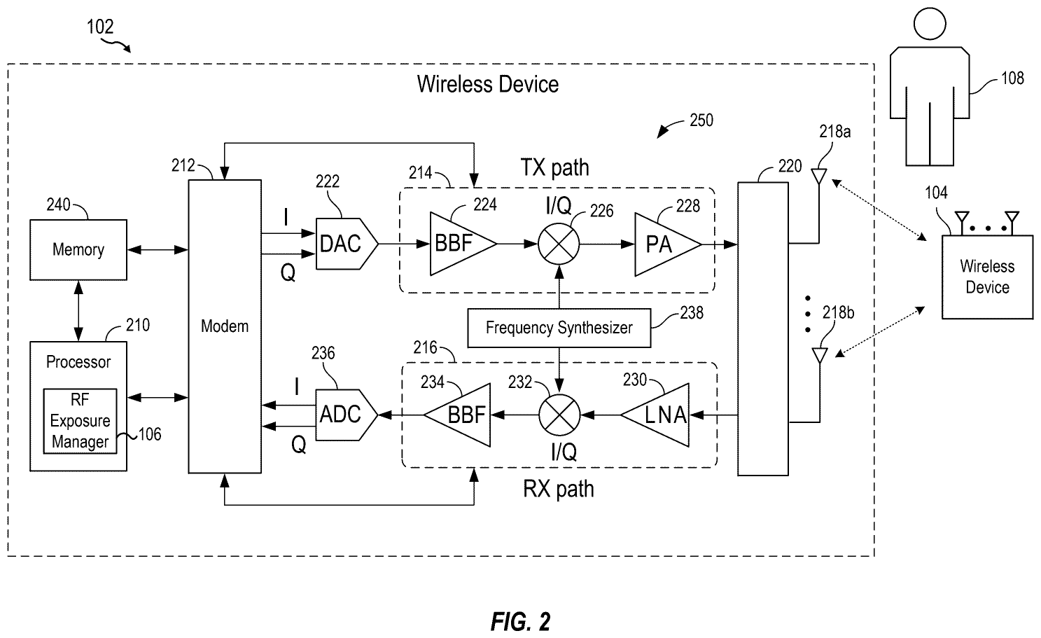

FIG. 2 illustrates example components of the wireless device 102, which may be used to communicate with any of the wireless devices 104, in some cases, in proximity to human tissue as represented by the human 108.

The wireless device 102 may be, or may include, a chip, system on chip (SoC), chipset, package or device that includes one or more modems 212. In some cases, the modem(s) 212 may include, for example, any of a WWAN modem (e.g., a modem configured to communicate via E-UTRA and/or 5G NR standards), a WLAN modem (e.g., a modem configured to communicate via 802.11 standards), a Bluetooth modem, a NTN modem, etc. In certain aspects, the wireless device 102 also includes one or more radios (collectively “the radio(s) 250”). In some aspects, the wireless device 102 further includes one or more processors, processing blocks, or processing elements (collectively “the processor 210”) and one or more memory blocks or elements (collectively “the memory 240”).

In certain aspects, the processor 210 may include a processor that is representative of an application processor that generates information (e.g., application data such as content requests) for transmission and/or receives information (e.g., requested content) via the modem 212. In some cases, the processor 210 may include a microprocessor associated with the modem 212, which may implement the RF exposure manager 106 and/or process any of certain protocol stack layers associated with a RAT. For example, the processor 210 may process any of an application layer, packet layer, WLAN protocol stack layers (e.g., a link or MAC layer), and/or WWAN protocol stack layers (e.g., a radio resource control (RRC) layer, a packet data convergence protocol (PDCP) layer, a radio link control (RLC) layer, and a MAC layer). In some cases, at least one of the modems 212 (e.g., the WWAN modem) may be in communication with one or more of the other modems 212 (e.g., the WLAN modem and/or Bluetooth modem). For example, the processor 210 may be representative of at least one of the modems 212 in communication with one or more of the other modems 212.

The modem 212 may include an intelligent hardware block or device such as an application-specific integrated circuit (ASIC), among other possibilities. The modem 212 may generally be configured to implement a physical (PHY) layer. For example, the modem 212 may be configured to modulate packets and to output the modulated packets to the radio(s) 250 for transmission over a wireless medium. The modem 212 is similarly configured to obtain modulated packets received by the radio(s) 250 and to demodulate the packets to provide demodulated packets. In addition to a modulator and a demodulator, the modem 212 may further include digital signal processing (DSP) circuitry, automatic gain control (AGC), a coder, a decoder, a multiplexer, and a demultiplexer (not shown).

As an example, while in a transmission mode, the modem 212 may obtain data from the processor 210. The data obtained from the processor 210 may be provided to a coder, which encodes the data to provide encoded bits. The encoded bits may be mapped to points in a modulation constellation (e.g., using a selected modulation and coding scheme) to provide modulated symbols. The modulated symbols may be mapped, for example, to spatial stream(s) or space-time streams. The modulated symbols may be multiplexed, transformed via an inverse fast Fourier transform (IFFT) block, and subsequently provided to DSP circuitry for transmit windowing and filtering. The digital signals may be provided to a digital-to-analog converter (DAC) 222. In certain aspects involving beamforming, the modulated symbols in the respective spatial streams may be precoded via a steering matrix prior to provision to the IFFT block.

The modem 212 may be coupled to the radio(s) 250 including a transmit (TX) path 214 (also known as a transmit chain) for transmitting signals via one or more antennas 218 and a receive (RX) path 216 (also known as a receive chain) for receiving signals via the antennas 218. When the TX path 214 and the RX path 216 share an antenna 218, the paths may be connected with the antenna via an interface 220, which may include any of various suitable RF devices, such as a switch, a duplexer, a diplexer, a multiplexer, and the like. As an example, the modem 212 may output digital in-phase (I) and/or quadrature (Q) baseband signals representative of the respective symbols to a DAC 222.

Receiving I or Q baseband analog signals from the DAC 222, the TX path 214 may include a baseband filter (BBF) 224, a mixer 226, and a power amplifier (PA) 228. The BBF 224 filters the baseband signals received from the DAC 222, and the mixer 226 mixes the filtered baseband signals with a transmit local oscillator (LO) signal to convert the baseband signal to a different frequency (e.g., upconvert from baseband to a radio frequency). In some aspects, the frequency conversion process produces the sum and difference frequencies between the LO frequency and the frequencies of the baseband signal. The sum and difference frequencies are referred to as the beat frequencies. Some beat frequencies are in the RF range, such that the signals output by the mixer 314 are typically RF signals, which may be amplified by the PA 228 before transmission by the antenna(s) 218. The antenna(s) 218 may emit RF signals, which may be received at the wireless device 104. While one mixer 226 is illustrated, several mixers may be used to upconvert the filtered baseband signals to one or more intermediate frequencies and to thereafter upconvert the intermediate frequency signals to a frequency for transmission.

In some cases, the wireless device 102 may communicate via multiple-input, multiple-output (MIMO) signals. The wireless device 102 may transmit more than one signal via multiple antennas 218a, 218b (collectively “the antennas 218”) to the wireless device 104 through multipath propagation. As an example, a first signal may be transmitted via the first antenna 218a, and a second signal may be transmitted via the second antenna 218b via a different propagation path than the first signal. The MIMO signals may facilitate increased communication link capacity (e.g., throughput) between the wireless device 102 and the wireless device 104.

The RX path 216 may include a low noise amplifier (LNA) 230, a mixer 232, and a baseband filter (BBF) 234. RF signals received via the antenna 218 (e.g., from the wireless device 104) may be amplified by the LNA 230, and the mixer 232 (which may comprise one or several mixers) mixes the amplified RF signals with a receive local oscillator (LO) signal to convert the RF signal to a baseband frequency (e.g., downconvert). The baseband signals output by the mixer 232 may be filtered by the BBF 234 before being converted by an analog-to-digital converter (ADC) 236 to digital I or Q signals for digital signal processing. The modem 212 may receive the digital I or Q signals and further process the digital signals (e.g., demodulating the digital signals).

Certain transceivers may employ frequency synthesizers with a voltage-controlled oscillator (VCO) to generate a stable, tunable LO frequency with a particular tuning range. Thus, the transmit LO frequency may be produced by a frequency synthesizer 238, which may be buffered or amplified by an amplifier (not shown) before being mixed with the baseband signals in the mixer 226. Similarly, the receive LO frequency may be produced by the frequency synthesizer 238, which may be buffered or amplified by an amplifier (not shown) before being mixed with the RF signals in the mixer 232. Separate frequency synthesizers may be used for the TX path 214 and the RX path 216.

While in a reception mode, the modem 212 may obtain digitally converted signals via the ADC 236 and RX path 216. As an example, in the modem 212, digital signals may be provided to the DSP circuitry, which is configured to acquire a received signal, for example, by detecting the presence of the signal and estimating the initial timing and frequency offsets. The DSP circuitry is further configured to digitally condition the digital signals, for example, using channel (narrowband) filtering, analog impairment conditioning (such as correcting for I/Q imbalance), and applying digital gain to ultimately obtain a narrowband signal. The output of the DSP circuitry may be fed to the AGC, which is configured to use information extracted from the digital signals, for example, in one or more received training fields, to determine an appropriate gain. The output of the DSP circuitry also may be coupled with the demodulator, which is configured to extract modulated symbols from the signal and, for example, compute the logarithm likelihood ratios (LLRs) for each bit position of each subcarrier in each spatial stream. The demodulator may be coupled with the decoder, which may be configured to process the LLRs to provide decoded bits. The decoded bits from all of the spatial streams may be fed to the demultiplexer for demultiplexing. The demultiplexed bits may be descrambled and provided to a medium access control layer (e.g., the processor 210) for processing, evaluation, or interpretation.

The processor 210 and/or modem 212 may control the transmission of signals via the TX path 214 and/or reception of signals via the RX path 216. In some aspects, the processor 210 and/or modem 212 may be configured to perform various operations, such as those associated with the methods described herein. The processor 210 and/or the modem 212 may include a microcontroller, a microprocessor, an application processor, a baseband processor, a MAC processor, a neural network processor, a digital signal processor (DSP), an application specific integrated circuit (ASIC), a field programmable gate array (FPGA) or other programmable logic device (PLD), discrete gate or transistor logic, discrete hardware components, or any combination thereof. In some cases, aspects of the processor 210 may be integrated with (incorporated in and/or shared with) the modem 212, such as the RF exposure manager 106, a microcontroller, a microprocessor, a baseband processor, a medium access control (MAC) processor, a digital signal processor, etc. The memory 240 may store data and program codes (e.g., computer-readable instructions) for performing wireless communications as described herein. The memory 240 may be external to the processor 210 and/or the modem 212 (as illustrated) and/or incorporated therein.

In certain cases, the RF exposure manager 106 (as implemented via the processor 210 and/or modem 212) may determine a respective imbalanced MIMO transmit power limit for each antenna involved in a MIMO transmission and determine a respective transmit power (e.g., corresponding to certain levels of gain(s) applied to a respective TX path 214 including the BBF 224, the mixer 226, and/or the PA 228) for each antenna that complies with an RF exposure limit, based at least in part on the respective imbalanced MIMO transmit power limit for the antenna.

FIG. 2 shows one reference example of a transceiver design. It will be appreciated that other transceiver designs or architectures may be applied in connection with certain aspects of the present disclosure. For example, while examples discussed herein utilize I and Q signals (e.g., quadrature modulation), those of skill in the art will understand that components of the transceiver may be configured to utilize any other suitable modulation, such as polar modulation. As another example, circuit blocks may be arranged differently from the configuration shown in FIG. 2, and/or other circuit blocks not shown in FIG. 2 may be implemented in addition to or instead of the blocks depicted.

### Example RF Exposure Compliance

In certain cases, compliance with an RF exposure limit may be performed as a time-averaged RF exposure evaluation within a specified running (moving) time window associated with the RF exposure limit. The RF exposure limit may specify a time-averaged RF exposure metric (e.g., SAR and/or PD) over the running time window. As an example, the Federal Communications Commission (FCC) specifies that certain SAR limits (general public exposure) are 0.08 W/kg, as averaged over the whole body, and a peak spatial-average SAR of 1.6 W/kg, averaged over any 1 gram of tissue (defined as a tissue volume in the shape of a cube) for sub-6 GHz bands, whereas certain PD limits are 1 mW/cm², as averaged over the whole body, and a peak spatial-average PD of 4 mW/cm², averaged over any 1 cm². The FCC also specifies the corresponding averaging time may be six minutes (360 seconds) for sub-6 GHz bands, whereas the averaging time may be 2 seconds for mmWave bands (e.g., 60 GHz frequency bands).

The RF exposure limit and/or corresponding averaging time window may vary based on the frequency band. In certain aspects, the RF exposure limit(s) and/or corresponding averaging time window(s), if applicable, may be specific to a particular geographic region or country, such as the United States, Canada, China, or European Union, as illustrative examples. In some cases, the RF exposure limit(s) may specify the maximum allowed RF exposure that can be encountered without time averaging. In such cases, the maximum allowed RF exposure may correspond to a maximum output or transmit power that can be used by the wireless device.

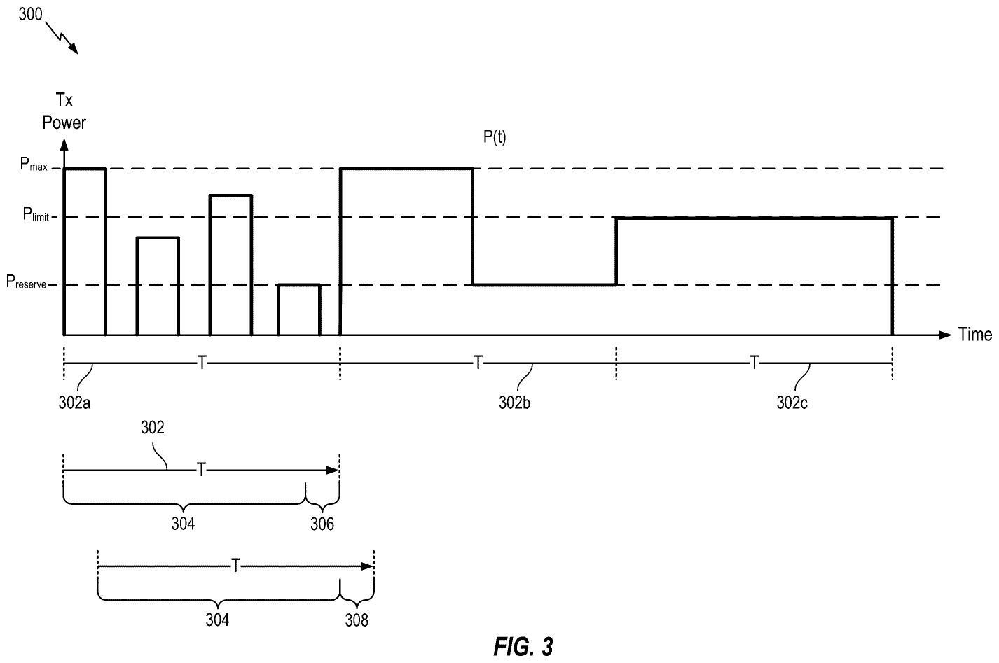

FIG. 3 is a graph 300 of a transmit power over time (P (t)) that varies over a running (e.g., rolling or moving) time window (T) associated with the RF exposure limit. The wireless device (e.g., the wireless device 102) may evaluate RF exposure compliance over the running time window 302 (T) based on past RF exposure (e.g., a transmit power report) in a past time interval 304 of the time window 302 and a future time interval 306. The wireless device may determine the maximum allowed transmit power for the future time interval 306 that satisfies the time-averaged RF exposure limit based on the past RF exposure used in the past time interval 304. The wireless device may perform such a time-averaging evaluation as the time window 302 moves over time, such as in the next future time interval 308, where the past time interval 304 now includes the previous future time interval 306.

The maximum time-averaged transmit power limit (Pₗᵢₘᵢₜ) represents the maximum transmit power the wireless device can transmit continuously for the duration of the running time window 302 (T) in compliance with the RF exposure limit. For example, the wireless device is transmitting continuously at Pₗᵢₘᵢₜ in the time window 302c such that the time-averaged transmit power over the time window (e.g., the time window 302c) is equal to Pₗᵢₘᵢₜ in compliance with the time-averaged RF exposure limit. The RF exposure level corresponding to time-averaged transmit power limit (Pₗᵢₘᵢₜ) may be referred to as an RF exposure design target. The RF exposure design target may be less than or equal to the RF exposure limit. The RF exposure design target may be selected to be less than the RF exposure limit to account for device uncertainty and/or to meet the RF exposure limit in exposure scenarios when transmitting simultaneously with other radios within the same device that have a different RF exposure controlling mechanism.

In certain cases, an instantaneous transmit power may exceed Pₗᵢₘᵢₜ in certain transmission occasions, for example, as shown in the time window 302a and the time window 302b. In some cases, the wireless device may transmit at Pₘₐₓ, which may be the maximum instantaneous transmit power supported by the wireless device, the maximum instantaneous transmit power the wireless device is capable of outputting, or the maximum instantaneous transmit power allowed by a standard or regulatory body (e.g., the maximum output power, P_{CMAX}). In some cases, the wireless device may transmit at a transmit power less than or equal to Pₗᵢₘᵢₜ in certain transmission occasions, for example, as shown in the time window 302a.

In certain cases, a reserve power may be used to enable a continuous transmission within a time window (T) when transmitting above Pₗᵢₘᵢₜ in the time window or to enable a certain level of quality for certain transmissions. As shown in the time window 302b, the transmit power may be backed off from Pₘₐₓ to a reserve power (Pᵣₑₛₑᵣᵥₑ) so that the wireless device can maintain a continuous transmission during the time window (e.g., maintain a radio connection with a receiving entity) in compliance with the time-averaged RF exposure limit. In the time window 302c, the wireless device may increase the transmit power to Pₗᵢₘᵢₜ in compliance with the time-averaged RF exposure limit. In some cases, Pᵣₑₛₑᵣᵥₑ may allow for a certain level of transmission quality for certain transmissions (e.g., control signaling). Pᵣₑₛₑᵣᵥₑ may be used to reserve transmit power for at least a portion of the time window 302 for certain transmissions (e.g., control signaling). Pᵣₑₛₑᵣᵥₑ may also be referred to as a “control power level” or “control level.”

In the time window 302b, the area between Pₘₐₓ and Pᵣₑₛₑᵣᵥₑ for the time duration of transmitting at Pₘₐₓ may be equal to the area between Pₗᵢₘᵢₜ and Pᵣₑₛₑᵣᵥₑ for the time window T, such that the area of transmit power (P (t)) in the time window 302b is equal to the area of Pₗᵢₘᵢₜ for the time window T. Such an area may be considered using 100% of the energy (transmit power or exposure) to remain compliant with the time-averaged RF exposure limit. Without the reserve power Pᵣₑₛₑᵣᵥₑ, the transmitter may transmit at Pₘₐₓ for a portion of the time window with the transmitter turned off for the remainder of the time window to ensure compliance with the time-averaged RF exposure limit.

In some aspects, the wireless device may transmit at a power that is higher than Pₗᵢₘᵢₜ, but less than Pₘₐₓ in the time-average mode illustrated in the time window 302b. While a single transmit burst is illustrated in the time window 302b, it will be understood that the wireless device may instead utilize a plurality of transmit bursts within the time window (T), where the transmit bursts are separated by periods during which the transmit power is maintained at or below Pᵣₑₛₑᵣᵥₑ. Further, it will be understood that the transmit power of each transmit burst may vary (either within the burst and/or in comparison to other bursts), and that at least a portion of the burst may be transmitted at a power above Pₗᵢₘᵢₜ.

In certain aspects, the wireless device may transmit at a power less than or equal to a fixed power limit (e.g., Pₗᵢₘᵢₜ) without considering past exposure and/or past transmit powers in terms of a time-averaged RF exposure. For example, the wireless device may transmit at a power less than or equal to Pₗᵢₘᵢₜ using a look-up table (comprising one or more values of Pₗᵢₘᵢₜ depending on an RF exposure scenario). The look-up table may provide one or more values of Pₗᵢₘᵢₜ depending on the transmit frequency, transmit antenna, radio configuration (single-radio or multi-radio) and/or RF exposure scenario (e.g., a device state index corresponding to head exposure, body or torso exposure, extremity or hand exposure, and/or hotspot exposure) encountered by the wireless device. Examples of RF exposure scenarios include cases where the wireless device is emitting RF signals proximate to human tissue, such as a user's head, hand, or body (e.g., torso), or where the wireless device is being used as a hotspot away from human tissue. Therefore, the RF exposure can be managed as a time-averaged RF exposure evaluation (e.g., illustrated in FIG. 3), managed using a look-up table or flat or maximum value, or using another strategy or algorithm, where a particular process of managing the RF exposure may be referred to herein as an RF exposure control scheme.

For certain aspects, a wireless device may exhibit or be configured with a transmission duty cycle. The wireless device may determine transmit power level(s) and/or reserve power level(s) in compliance with the time-averaged RF exposure limit based on the duty cycle. The transmission duty cycle may be indicative of a share (e.g., 5 ms) of a specific period (e.g., 500 ms) in which the wireless device transmits RF signals. The duty cycle may be a ratio of the share to the specific period (e.g., 100 ms/500 ms), where the duty cycle may be represented as a number from zero to one. For example, in the time window 302a, the duty cycle may be greater than 50% of the duration of the time window (T), whereas in the time window 302b, the duty cycle may be equal to 100% of the duration of the time window (T).

In certain cases, the duty cycle may be standardized (e.g., predetermined) with a specific RAT and/or vary over time, for example, due to changes in radio conditions, mobility, and/or user behavior. As an example, certain RATs may specify the uplink duty cycle in the form of a time division duplexing (TDD) configuration, such as a TDD uplink-downlink (UL-DL) slot pattern in 5G NR or similar TDD patterns in E-UTRA or UMTS. In 5G NR, the TDD UL-DL slot pattern may specify the number of uplink slots and corresponding position in time associated with the uplink slots in a sequence of slots, such that the total number of uplink slots with respect to the total number of slots in the sequence is indicative of the duty cycle. In certain aspects, the duty cycle may correspond to the actual duration for past transmissions scheduled or used, for example, within the TDD UL-DL slot pattern. For example, although the wireless device may be configured with a TDD UL-DL slot pattern, the wireless device may use a portion or subset of the UL slots for transmitting RF signals. Thus, the duty cycle for the wireless device may be less than the maximum available duty cycle corresponding to the TDD UL-DL slot pattern.

### Example RF Exposure Measurements

In certain cases, the RF exposure of a wireless device may be certified with a regulatory agency (e.g., the FCC for the United States or the Innovation, Science and Economic Development Canada (ISED) for Canada). Spatial measurements may be taken with respect to a model (phantom) representing the human body, where the model may be filled with a liquid simulating human tissue. As discussed above, the first wireless device 102 may simultaneously transmit signals using the first technology (e.g., 3G, 4G, IEEE 802.11ac, etc.) and the second technology (e.g., 5G, IEEE 802.11ad, etc.), in which RF exposure is measured using different metrics for the first technology and the second technology (e.g., SAR for the first technology and PD for the second technology). With respect to PD, RF exposure can be measured using incident PD or absorbed PD. The RF exposure measurements may be performed differently for each transmit scenario and include, for example, electric field measurements using a model of a human body. RF exposure values and/or distributions (simulation and/or measurement) may then be generated per transmit antenna/configuration (beam) on various evaluation surfaces/positions at various locations.

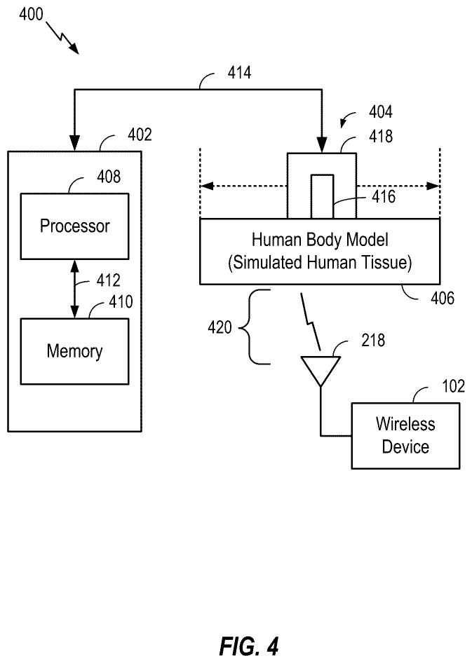

FIG. 4 is a diagram illustrating an example system 400 for measuring RF exposure levels (e.g., values and/or distributions) associated with a wireless communication device (e.g., the wireless device 102). As shown, the RF exposure measurement system 400 includes a processing system 402, a (robotic) RF probe 404, and a human body model 406. The RF exposure measurement system 400 may take RF measurements at various transmit scenarios. As used herein, a transmit scenario may correspond to various combinations of radios, communication technologies (e.g., RATs), antennas, antenna groupings, antenna configurations, frequency bands, operating conditions, RF exposure scenarios (e.g., head exposure, body-worn exposure, extremity (hand) exposure, and/or hotspot exposure), device use-case scenarios (e.g., based on active applications on the device, such as voice vs. data applications, gaming vs. video-call applications active on the device), and/or geographical locations or regions (e.g., countries or regions) associated with the wireless device 102. In some examples, these measurements may be used to generate an RF exposure map (or RF exposure distribution) and determine suitable transmit power limits for the transmit powers of the antenna(s) 218 in compliance with one or more RF exposure limits, as further described herein. The wireless device 102 may emit electromagnetic radiation via the antenna(s) 218 at various transmit powers, and the RF exposure measurement system 400 may take RF measurements via the robotic RF probe 404 (e.g., to determine RF exposure map(s) for the antenna(s) 218). Transmit power limits (e.g., Pₗᵢₘᵢₜ) for the various transmit scenarios associated with the wireless device 102 may be determined based on the RF measurements and/or exposure maps. Note that while measurements are described as being performed with respect to the wireless device 102, measurements may be taken with respect to a (different) representative device (e.g., a sample device for testing purposes), and then transmit power limits loaded into or otherwise provided or conveyed to the wireless device 102 (e.g., the devices manufactured for end-users).

In some cases, a test separation distance 420 (or spacing) may be adjusted (increased or decreased) depending on the transmit scenario, where the test separation distance 420 may be the distance between a radiating structure (e.g., the antenna(s) 218) and any part of the human body, in this example, the human body model 406. For example, the test separation distance 420 may be set to 15 millimeters (mm) for body-worn exposure, 0 mm for head exposure, 10 mm for a hotspot exposure, etc. In certain cases, the test separation distance 420 may differ among regions. For example, the test separation distance 420 may be set to 0 mm for body-worn exposure for a particular region, whereas the test separation distance 420 may be set to 15 mm for body-worn exposure for another region, and in some cases, using the same RF exposure limit (e.g., 1.6 W/kg averaged over 1 gram). As the test separation distance 420 may differ among some regions, the corresponding transmit power limits (e.g., Pₗᵢₘᵢₜ) may differ among these regions regardless of whether the same RF exposure limit is applied.

The processing system 402 may include a processor 408 coupled to a memory 410 via a bus 412. The processing system 402 may be a computational device such as a computer. The processor 408 may include a microprocessor, a central processing unit (CPU), a graphics processing unit (GPU), a neural networks processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. The processor 408 may be in communication with the robotic RF probe 404 via an interface 414 (such as a computer bus interface), such that the processor 408 may obtain RF measurements taken by the robotic RF probe 404 and control the position of the robotic RF probe 404 relative to the human body model 406, for example.

The memory 410 may be configured to store instructions (e.g., computer-executable code) that when executed by the processor 408, cause the processor 408 to perform various operations. For example, the memory 410 may store instructions for obtaining the RF exposure values or distributions associated with various RF exposure/transmit scenarios and/or adjusting the position of the robotic RF probe 404.

The robotic RF probe 404 may include an RF probe 416 coupled to a robotic arm 418. In some aspects, the RF probe 416 may be a dosimetric probe capable of measuring RF exposures at various frequencies such as sub-6 GHz bands and/or mmWave bands. The RF probe 416 may be positioned by the robotic arm 418 in various locations (as indicated by the dotted arrows) to capture the electromagnetic radiation emitted by the antenna(s) 218 of the first wireless device 102. The robotic arm 418 may be a six-axis robot capable of performing precise movements to position the RF probe 416 to the location (on the human body model 406) of maximum electromagnetic field generated by the first wireless device 102. In other words, the robotic arm 418 may provide six degrees of freedom in positioning the RF probe 416 with respect to the antenna(s) 218 of the first wireless device 102 and/or the human body model 406.

The human body model 406 may be a specific anthropomorphic mannequin with simulated human tissue. For example, the human body model 406 may include one or more liquids that simulate the human tissue of the head, body, and/or extremities. The human body model 406 may simulate the human tissue for determining the maximum permissible transmission power of the antenna(s) 218 in compliance with various RF exposure limits implemented in various regions.

In certain aspects, the RF exposure levels associated with the wireless device 102 may be measured without the human body model 406. For example, the RF probe 416 may be an electric- or magnetic-field probe capable of estimating the SAR and/or PD exposure encountered by human tissue in the free-space surrounding the wireless device 102. While the example depicted in FIG. 4 is described herein with respect to obtaining RF exposure levels with a robotic RF probe to facilitate understanding, aspects of the present disclosure may also be applied to other suitable RF probe architectures, such as using multiple stationary RF probes positioned at various locations along the human body model 406 or free-space.

For a wireless device, a particular Pₗᵢₘᵢₜ may be defined per radio, RAT, frequency band (or carrier, channel, etc.), antenna, antenna group, antenna configuration, operating condition, RF exposure scenario (e.g., head exposure, body-worn exposure, hand exposure, hotspot exposure, etc.), device use-case scenario, and/or geographical location or region (collectively referred to herein as a “transmit scenario”). In some cases, the RF exposure scenario may correspond to a device state index (DSI) or a particular operational state of the device, where the DSI may indicate the device position relative to a human body, e.g., head, hand, body, etc. In certain cases, Pₗᵢₘᵢₜ may correspond to a particular RF exposure design target (e.g., SAR, incident PD, or absorbed PD), where a separate Pₗᵢₘᵢₜ may be determined for each RF exposure distribution (or, more generally, each transmit scenario), for example, as described herein with respect to FIG. 4. As an example, Pₗᵢₘᵢₜₖ for the k^{th} RF exposure distribution may be given by:

$${P}_{limitk} = {Tx}_{k} * RF\_exposure \_design \_target / max ( RF . ex {p}_{k} ) \qquad ( 1 )$$

where max (RF.expₖ) is the largest RF exposure value (e.g., SAR value, incident PD value, or absorbed PD value) in the k^{th} RF exposure distribution (RF.expₖ) measured with radio at transmit power Txₖ, Txₖ is the transmit power applied at the antenna while collecting the k^{th} RF exposure distribution, and RF_exposure_design_target may be a target RF exposure limit. In certain cases, RF_exposure_design_target may be lower than the regulatory RF exposure limit to account for device uncertainties and/or to budget enough RF exposure margin to comply with total RF exposure in simultaneous transmission scenarios with other transmitters not included inside the RF exposure time-averaging operation. A regulatory exposure limit may include an RF exposure limit set by a regulatory body (e.g., the FCC) and/or provided by a standards body (e.g., the IEEE or ICNIRP). Thus, the time-averaged RF exposure exhibited by a wireless device may be kept in compliance with the respective regulatory RF exposure limit by maintaining the time-averaged transmit power for the k^{th} RF exposure distribution to less than or equal to Pₗᵢₘᵢₜₖ. Pₗᵢₘᵢₜₖ may vary with technology, operating frequency band, transmitting antenna, and/or device position relative to the human body (which may be referred to as “device state index”) (or, more generally, a transmit scenario). In certain cases, the Pₗᵢₘᵢₜₖ for the k^{th} RF exposure distribution (in Equation 1) may be referred to as a single-input, single-output (SISO) Pₗᵢₘᵢₜ.

As RF exposure is proportional to transmit power, a time-averaging algorithm may perform RF exposure averaging based on past transmitted powers by scaling the stored Pₗᵢₘᵢₜₛ, e.g., according to the following:

$$RF . exp ( t ) = {\sum }_{k = 1}^{m} \frac{{Tx}_{k} ( t )}{{P}_{limitk}} \cdot RF\_exp \_design \_target \qquad ( 2 )$$

where RF.exp (t) is the instantaneous total RF exposure out of all active transmitters, Pₗᵢₘᵢₜₖ is the Pₗᵢₘᵢₜ (e.g., SISO Pₗᵢₘᵢₜ) corresponding to the k^{th} transmitter at Txₖ (t) instantaneous power.

In certain cases, the time-averaged RF exposure exhibited by a wireless device may be kept in compliance with the respective regulatory RF exposure limit by maintaining the total RF exposure to less than or equal to the RF exposure limit, e.g., according to the following:

$$time . avg . RF . exp = \frac{1}{T} {\int }_{t - T}^{T} RF . exp ( t ) dt \leq RF . exp . limit \qquad ( 3 )$$

Alternatively, in certain cases, the time-averaged RF exposure exhibited by a wireless device may be kept in compliance with the respective regulatory RF exposure limit by maintaining the total RF exposure to less than or equal to the RF exposure design target, e.g., according to the following:

$$time . avg . RF . exp = \frac{1}{T} {\int }_{t - T}^{T} RF . exp ( t ) dt \leq RF . exp . design . target \qquad ( 4 )$$

In the latter case (e.g., Equation 4), the time-averaged calculations may be performed in normalized exposure (NE) terms based on the Pₗᵢₘᵢₜ corresponding to the k^{th} transmitter transmitting at Txₖ (t) instantaneous power, e.g., according to the following:

$$time . avg . NE = \frac{1}{T} {\int }_{t - T}^{T} [ {\sum }_{k = 1}^{m} {NE}_{k} ( t ) ] dt = \frac{1}{T} {\int }_{t - T}^{T} [ {\sum }_{k = 1}^{m} \frac{{Tx}_{k} ( t )}{{P}_{limit k}} ] dt \leq 1 \qquad ( 5 )$$

### Example Balanced MIMO Transmit Power Limit

As noted, certain wireless devices may perform MIMO transmission based on a balanced MIMO Pₗᵢₘᵢₜ defined for antennas involved in the MIMO transmission. As used herein, a balanced MIMO Pₗᵢₘᵢₜ may refer to a respective same transmit power limit for each of the antennas involved in the MIMO transmission, such that each antenna transmits at a same transmission power level during the MIMO transmission in compliance with an RF exposure limit. For a 2×2 MIMO transmission, for example, a balanced 2×2 MIMO Pₗᵢₘᵢₜ may be defined per antenna pair for a given transmit scenario (e.g., RAT/frequency band/DSI). In this example, the balanced MIMO Pₗᵢₘᵢₜ for both antennas (i, j) of an antenna pair when transmitting at a same reference transmission power level Tx (referred to as a maximum time-averaged power limit MIMO.P_{limit(i,j)}) corresponding to an RF exposure design target may be given by the following:

$$MIMO . {P}_{limit ( i , j )} = {Tx}_{( i , j )} * RF exposure design target / max ( RF . {exp}_{( i , j )} ) \qquad ( 6 )$$

where max (RF.exp_{(i, j)}) is the maximum value (e.g., largest RF exposure value) in the MIMO RF exposure distribution for antenna pair (i, j) when both antennas are transmitting at a same transmission power Tx_{(i, j)} during the MIMO transmission. MIMO.P_{limit(i,j)} may vary with the transmit scenario (e.g., RAT, operating frequency band, transmitting antenna pair, and/or DSI, among others).

In the case of MIMO transmissions, since RF exposure is proportional to transmit power, a time-averaging algorithm may perform RF exposure averaging based on past transmitted powers by scaling the stored SISO Pₗᵢₘᵢₜₛ and MIMO Pₗᵢₘᵢₜₛ. In certain cases, the total RF exposure from simultaneous transmissions from “n” SISO transmitters and “m” 2×2 MIMO transmitters may be represented using the following:

$$RF . exp ( t ) = {\sum }_{k = 1}^{n} \frac{{Tx}_{k} ( t )}{{P}_{limitk}} \cdot RF\_exp \_design \_target + {\sum }_{( i , j ) = 1}^{m} \frac{{Tx}_{( i , j )} ( t )}{MIMO . {P}_{limit ( i , j )}} \cdot RF\_exp \_design \_target \qquad ( 7 )$$

where RF.exp (t) is the instantaneous total RF exposure out of all active transmitters, Pₗᵢₘᵢₜₖ is the Pₗᵢₘᵢₜ corresponding to the k^{th} SISO transmitter transmitting at Txₖ (t) instantaneous power, MIMO. P_{limit(i,j)} is the balanced MIMO. Pₗᵢₘᵢₜ corresponding to the 2×2 MIMO transmitter transmitting at a same Tx_{(i,j)} (t) instantaneous power out of each antenna i and j.

With Equation 7, the time-averaged RF exposure exhibited by a wireless device may be kept in compliance with the respective regulatory RF exposure limit by maintaining the total RF exposure to less than or equal to the RF exposure design target (e.g., according to Equation 4). In certain cases, the time-averaged calculations for Equations 4/7 may be performed in normalized exposure (NE) terms relative to SISO Pₗᵢₘᵢₜ and MIMO Pₗᵢₘᵢₜ, e.g., using the following:

$$time . avg . NE = \frac{1}{T} {\int }_{t - T}^{T} [ {\sum }_{k = 1}^{n} {NE}_{k} ( t ) + {\sum }_{( i , j ) = 1}^{m} {NE}_{( i , j )} ( t ) ] dt = \frac{1}{T} {\int }_{t - T}^{T} [ {\sum }_{k = 1}^{n} \frac{{Tx}_{k} ( t )}{{P}_{limitk}} + {\sum }_{( i , j ) = 1}^{m} \frac{{Tx}_{( i , j )} ( t )}{MIMO . {P}_{limit ( i , j )}} ] dt \leq 1 \qquad ( 8 )$$

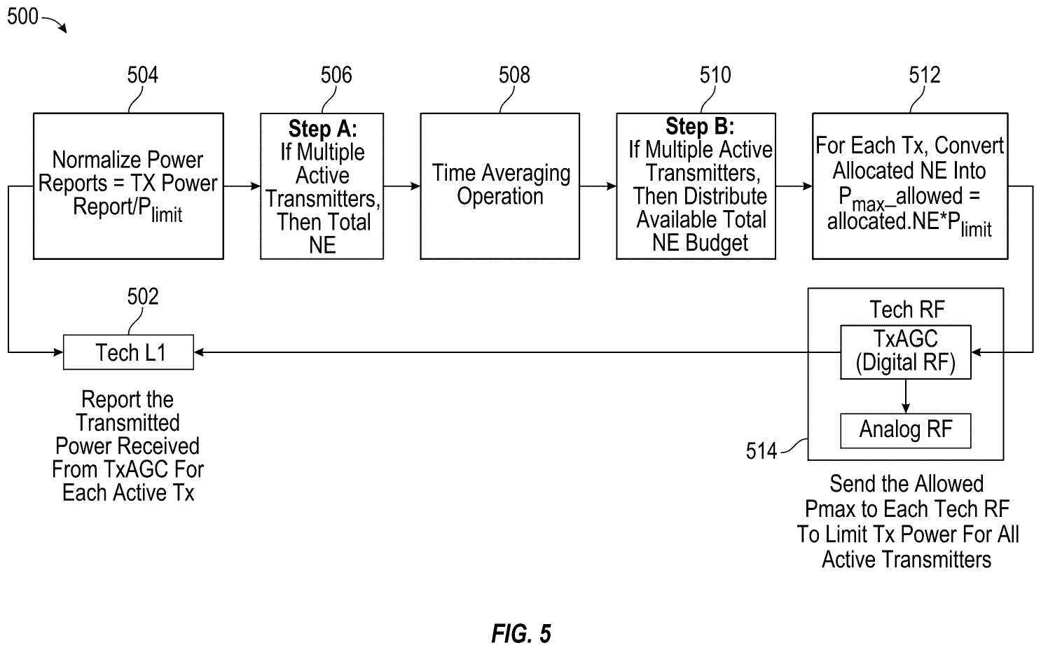

FIG. 5 is a flow diagram illustrating example operations 500 for managing a time-averaged RF exposure evaluation. The operations 500 may be performed, for example, by a wireless device (e.g., the UE 120a).

The operations 500 may optionally begin, at block 502, where the wireless device may obtain the transmit power used for a particular time interval (e.g., a second time interval 306) in a running time window (T) associated with a time-averaged RF exposure limit. The transmit power may be obtained from a transmit automatic gain control (TxAGC) module at Layer-1 (L1) of a protocol stack. For example, L1 may include the physical radio layer (PHY) of the protocol stack. In certain aspects, the processor 210 and/or modem 212 of the wireless device 102 may obtain (or access) the transmit power used for the particular time interval. The processor 210 and/or modem 212 may include the TxAGC module and track the transmit power output by the transmit path over time. A transmit power report of the past transmit powers may be representative of actual transmit power(s) within an expected device uncertainty.

At block 504, the wireless device may determine a normalized power report of past transmit powers (referred to herein as a consumed exposure or normalized exposure (NE)). The normalized power report for a particular time interval may be a past time-averaged transmit power during a time interval, normalized using Pₗᵢₘᵢₜ. For example, the normalized power report (e.g., consumed exposure) may be equal to the past time-averaged transmit power(s) divided by Pₗᵢₘᵢₜ (e.g., Normalized Power Report=Tx Power Report/Pₗᵢₘᵢₜ), where the transmit power(s) associated with the particular time interval are averaged over that time interval. Such normalized power reports may be computed and tracked for multiple time intervals (e.g., corresponding to the past transmit powers) belonging to a running time window (T). The wireless device may determine an average of the normalized power reports associated with the past transmit powers.

At block 506, if there are multiple transmitters active, then the wireless device may determine a total normalized power report (e.g., total consumed exposure or NE) of past transmit powers for the multiple transmitters over the prior time interval within the running time window (T).

At block 508, the wireless device may perform a time-averaging operation to determine a normalized exposure (NE) margin allowed for the next time interval in the time window (T) such that the time average of the normalized power report and the exposure margin for the next time interval satisfy the time-averaged RF exposure limit. In certain aspects, the exposure margin may be the maximum RF exposure that the wireless device can produce and satisfy the time-averaged RF exposure limit. The normalized exposure margin may be the percentage of exposure remaining with respect to the normalized power report and the time-averaged RF exposure limit. For example, the time-averaged RF exposure limit may be satisfied when the time average of the normalized power report and the exposure margin for the next time interval is less than or equal to one (e.g., the normalized RF exposure limit). In terms of the allowable transmit power for the next time interval, the normalized exposure margin represents the percentage of the maximum time-averaged RF exposure power level Pₗᵢₘᵢₜ.

At block 510, if there are multiple transmitters active, then the wireless device may distribute the available total NE margin allowed for the next time interval among the active transmitters.

At block 512, the wireless device may determine the maximum allowed transmit power (P_{max_allowed}) for the next time interval for each transmitter. For example, for each transmitter, the maximum allowed transmit power (P_{max_allowed}) may be equal to the product of the normalized exposure margin for the transmitter determined at block 510 and Pₗᵢₘᵢₜ.

At block 514, the wireless device may provide the maximum allowed transmit power to transceiver circuitry (e.g., the transceiver depicted in FIG. 2). For example, the TxAGC module may obtain the maximum allowed transmit power as digital RF information (e.g., a particular gain index associated with an output power of the transmit path depicted in FIG. 2), and the TxAGC module may control the gains applied to circuitry in the transmit path to output a signal (e.g., an analog RF signal) at the transmit power associated with the digital RF information.

In certain cases, a wireless device may support MIMO transmission with SISO Pₗᵢₘᵢₜₛ as opposed to with MIMO Pₗᵢₘᵢₜₛ. In such cases, the wireless device may treat a MIMO transmission with multiple antennas as separate radio transmissions where each radio's exposure is independent from each other radio's exposure. For example, for a 2×2 MIMO transmission, the wireless device may treat the 2×2 MIMO transmission as 2 radio transmissions, where each radio's exposure is independent of the other radio's exposure. Note, SISO Pₗᵢₘᵢₜₛ may be used for 2×2 MIMO transmission if meas.MIMO.RFexposure≤meas. RFexposure1+meas.RFexposure2; otherwise, the SISO Pₗᵢₘᵢₜₛ may have to be reduced.

Assuming a 2×2 MIMO transmission with SISO Pₗᵢₘᵢₜₛ, the operations at block 506 may involve determining the total NE at each time interval using the following:

$$total . NE ( t ) = {\sum }_{k = 1}^{n} \frac{{Tx}_{k} ( t )}{{P}_{limitk}} = \frac{{Tx}_{1} ( t )}{{P}_{limit 1}} + \frac{{Tx}_{2} ( t )}{{P}_{limit 2}} \qquad ( 9 )$$

Additionally, the operations at block 510 may involve distributing the available total NE(t+Δt) for a future time interval Δt. In particular, each radio may be allocated a portion (ratio ‘rₖ’), such that the sum of portions for all active radios is 1 (e.g., r₁+r₂+ . . . +rₙ=1). In the case of 2×2 MIMO transmission, the available total NE budget for the next time interval can be split evenly (e.g., r₁=r₂=0.5). This allocated NE may be converted into a maximum transmission power limit for a future time interval, e.g., according to the following:

$${Pmax}_{k} ( t + Δ t ) = {r}_{k} * available . total . NE ( t ) * {P}_{limitk} \qquad ( 10 )$$

In a balanced 2×2 MIMO transmission scenario (e.g., both antennas transmit at a same transmission power) with SISO Pₗᵢₘᵢₜₛ, the minimum Pₘₐₓ out of two antennas (e.g., may be sent to transceiver circuitry to be RF exposure compliant (e.g., min {Pmax1 (t+Δt), Pmax2 (t+Δt)}). Thus, assuming an even split of the available total NE budget, the maximum transmission power limit for a future time interval may be represented with the following:

$${Pmax}_{k} ( t + Δ t ) = 0.5 * available . total . NE ( t ) * min \{ Plimit 1 , Plimit 2 \} \qquad ( 11 )$$

In certain cases, a wireless device may support MIMO transmission with a balanced MIMO Pₗᵢₘᵢₜ. In such cases, assuming a 2×2 MIMO transmission, the operations at block 506 may involve determining the total NE at each time interval using the following:

$$total . NE ( t ) = {\sum }_{( i , j ) = 1}^{m} \frac{{Tx}_{( i , j )} ( t )}{MIMO . {P}_{limit ( i , j )}} \qquad ( 12 )$$

where m=1. If both antennas transmit at the same power in the past time interval, then the total NE in Equation 12 may be represented with the following:

$$total . NE ( t ) = \frac{{Tx}_{( 1 , 2 )} ( t )}{MIMO . {P}_{limit ( 1 , 2 )}} \qquad ( 13 )$$

where MIMO.P_{limit (1,2)} is the balanced MIMO Pₗᵢₘᵢₜ for the 2×2 MIMO transmission. On the other hand, if both antennas transmit at different transmission powers (Tx1 and Tx2) in the past time interval, then a conservative value (e.g., maximum of the two transmission powers) may be used to determine the total NE. Here, the total NE in Equation 12 may be represented with the following:

$$total . NE ( t ) = \frac{max \{ {Tx}_{1} ( t ) , {Tx}_{2} ( t ) \}}{MIMO . {P}_{limit ( 1 , 2 )}} \qquad ( 14 )$$

Additionally, assuming a 2×2 MIMO transmission with a balanced MIMO Pₗᵢₘᵢₜ, the operations at block 510 may involve distributing the available total NE (t+Δt) for a future time interval Δt. Here, since there is a single active transmission, an additional split may not be needed in the available total NE. Accordingly, the Pₘₐₓ for both antennas for the future time interval may be represented with the following:

$$MIMO . {Pmax}_{( 1 , 2 )} ( t + Δ t ) = available . total . NE ( t ) * MIMO . {P}_{limit ( 1 , 2 )} \qquad ( 15 )$$

One potential advantage of using a balanced MIMO Pₗᵢₘᵢₜ compared to multiple SISO Pₗᵢₘᵢₜₛ for a MIMO transmission is that, for any antenna pair, MIMO. P_{limit (1,2)}≤min {Pₗᵢₘᵢₜ₁, Pₗᵢₘᵢₜ₂}. In scenarios where the MIMO antennas are spatially far apart with minimal overlap in RF exposure hotspots from both antennas, then MIMO.P_{limit(1,2)}=min {Pₗᵢₘᵢₜ₁, Pₗᵢₘᵢₜ₂}. Thus, using the MIMO Pₗᵢₘᵢₜ may allocate a higher Pₘₐₓ=available.total.NE(t)*MIMO. P_{limit(i,j)} when compared to 0.5*available.total.NE(t)*min{Pₗᵢₘᵢₜ₁, Pₗᵢₘᵢₜ₂} obtained using SISO Pₗᵢₘᵢₜₛ.

As noted, however, one potential drawback to using a balanced MIMO Pₗᵢₘᵢₜ for a MIMO transmission is that the balanced MIMO Pₗᵢₘᵢₜ can impact the performance of the wireless device in terms of reduced throughput, increased latency, and lower transmission range, as illustrative examples. For example, the balanced MIMO Pₗᵢₘᵢₜ is generally determined in part on the maximum value (e.g., largest RF exposure value) in the MIMO RF exposure distribution for the antennas when each antenna transmits at a same transmission power during the MIMO transmission. If multiple antennas are spatially apart, the RF exposure distribution for the antennas may result in multiple hotspots, where each hotspot is closer to each antenna's physical location. In certain cases, however, the amplitudes of the multiple hotspots may not be the same. In such cases, the dominant hotspot (e.g., largest RF exposure value) among the multiple hotspots is generally considered in determining the overall balanced MIMO Pₗᵢₘᵢₜ, thereby, disadvantaging one or more other antennas that have non-dominant hotspot exposures (e.g., lower exposures). In other words, one or more of these other antennas could potentially have transmitted at a higher transmission power than the antenna with the dominant hotspot.

### Example RF Exposure Compliance Using Imbalanced MIMO Transmit Power Limits

Aspects of the present disclosure provide apparatus and methods for RF exposure compliance based at least in part on imbalanced MIMO Pₗᵢₘᵢₜₛ. For example, certain aspects provide techniques for determining a respective MIMO Pₗᵢₘᵢₜ for each antenna such that the RF exposure hotspot associated with each antenna is in compliance with an RF exposure limit (e.g., time-averaged RF exposure limit) and at least two transmit powers for at least two antennas involved in the MIMO transmission are different. Additionally, certain aspects provide techniques for performing a MIMO transmission with multiple antennas, based at least in part on the imbalanced MIMO Pₗᵢₘᵢₜₛ.

The apparatus and methods for RF exposure compliance based at least in part on imbalanced MIMO Pₗᵢₘᵢₜₛ described herein may provide various advantages. For example, enabling multiple MIMO antennas to transmit at different transmission power levels during a MIMO transmission may improve the performance of the wireless device in terms of increased throughput, reduced latency, and/or increased transmission range, as illustrative, non-limiting examples.

In certain aspects, imbalanced MIMO Pₗᵢₘᵢₜₛ for antennas involved in a MIMO transmission may be determined using an iterative-based approach. For example, assuming a 2×2 MIMO transmission, an imbalanced MIMO.Pₗᵢₘᵢₜ₁ and imbalanced MIMO.Pₗᵢₘᵢₜ₂ may be determined via the iterative-based approach such that the respective RF exposure hotspot at each antenna location is equal to an RF exposure design target.

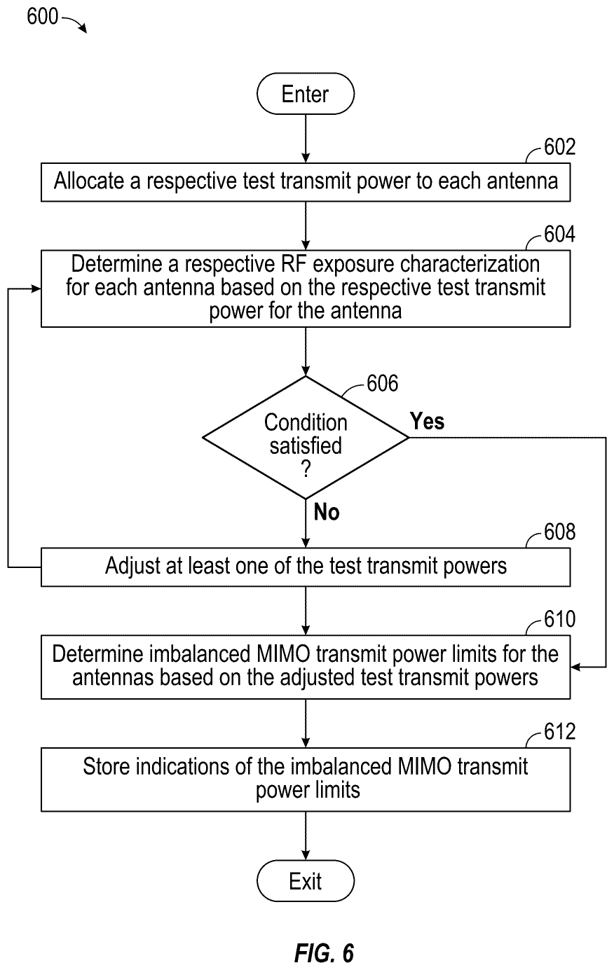

By way of example, FIG. 6 is a flow diagram illustrating example operations 600 for determining imbalanced MIMO Pₗᵢₘᵢₜₛ. The operations 600 may be performed, for example, by a processing system (e.g., processing system 402) and/or an RF exposure measurement system (e.g., RF exposure measurement system 400).

The operations 600 may optionally begin, at block 602, where the processing system may allocate a respective test transmit power to each antenna associated with a MIMO transmission. In certain aspects, each test transmit power that is allocated may be less than Pₘₐₓ. For example, for a 2×2 MIMO transmission, the processing system may allocate a test transmit power Pₜₑₛₜ₁ for antenna 1 and a test transmit power Pₜₑₛₜ₂ for antenna 2, such that Pₜₑₛₜ₁<Pₘₐₓ and Pₜₑₛₜ₂<Pₘₐₓ for both MIMO chains.

At block 604, the processing system may determine a respective RF exposure characterization (e.g., RF exposure map or distribution) for each antenna based on the respective test transmit power for the antenna in the MIMO transmission. For example, continuing with the aforementioned 2×2 MIMO transmission, the processing system may measure MIMO.RF.exposure1 for the MIMO antenna pair using Equation 16 and measure MIMO.RF.exposure2 for the MIMO antenna pair using Equation 17:

$$maximum MIMO . RF . exposure 1 = combined . RFexposure 1 at location 1 closer to antenna 1 \text{} when transmitting in MIMO condition out of antenna 1 \text{} transmitting at Ptest 1 and antenna 2 transmitting at Ptest 2 \qquad ( 16 )$$

$$maximum MIMO . RF . exposure 2 = combined . RFexposure 2 at location 2 closer to antenna 2 \text{} when transmitting in MIMO condition out of antenna 1 \text{} transmitting at Ptest 1 and antenna 2 transmitting at Ptest 2 \qquad ( 17 )$$

At block 606, the processing system determines whether the RF exposure characterizations satisfy a predetermined condition. The predetermined condition may include the RF exposure characterization for each antenna being within a threshold difference to each other RF exposure characterization for each other antenna. If the predetermined condition is satisfied, then the operations 600 proceed to block 610. If the predetermined condition is not satisfied, then the operations 600 proceed to block 608.

At block 608, the processing system may adjust at least one of the test transmit powers. In certain aspects, the operations in block 606 may be iteratively performed while the predetermined condition is unsatisfied. By way of example, continuing with the aforementioned 2×2 MIMO transmission scenario, if MIMO.RF.exposure1 is different from MIMO.RF.exposure2, then the processing system may iteratively adjust (e.g., increase/decrease) Pₜₑₛₜ₁ and/or Pₜₑₛₜ₂, and re-measure the RF exposure characterizations (in block 604) until the MIMO RF exposure values at both locations is similar (e.g., combined.RFexposure 1≈combined.RFexposure2≈combined.RFexposure).

At block 610, the processing system may determine imbalanced MIMO Pₗᵢₘᵢₜₛ for the antennas based on the adjusted test transmit powers (assuming block 608 is performed). In certain aspects, the operations in block 610 may involving determining a respective imbalanced MIMO Pₗᵢₘᵢₜ for each antenna based on the respective test transmit power determined for the antenna via blocks 604/608. By way of example, continuing with the aforementioned 2×2 MIMO transmission scenario, the processing system, at block 610, may determine imbal.MIMO.Pₗᵢₘᵢₜ₁ using Equation 18 and imbal.MIMO.Pₗᵢₘᵢₜ₂ using Equation 19:

$$imbalance . MIMO . {P}_{limit 1} = final iteration {P}_{test 1} * RF exposure design target / combined . RFexposure \qquad ( 18 )$$

$$imbalance . MIMO . {P}_{limit 2} = final iteration {P}_{test 2} * RF exposure design target / combined . RFexposure \qquad ( 19 )$$

At block 612, the processing system may store indications of the imbalanced MIMO Pₗᵢₘᵢₜₛ. In some aspects, the imbalanced MIMO Pₗᵢₘᵢₜₛ may be in the form of a look-up table (or other data structure) including one or more values of the imbalanced MIMO Pₗᵢₘᵢₜ for each antenna depending on the transmit scenario. Such a look-up table may be stored in the memory of the wireless device, such as the memory 240. In some aspects, the look-up table (or data structure) may be converted and/or compressed to a computer-readable dataset format, such as SQLite, JavaScript Object Notation (JSON), Extensible Markup Language (XML), or any other suitable dataset format. The look-up table (or data structure) may be generated by an RF exposure measurement system (e.g., RF exposure measurement system 400). In certain aspects, the look-up table (or data structure) may be generated as part of an RF exposure compliance certification procedure.

In certain aspects, imbalanced MIMO Pₗᵢₘᵢₜₛ for antennas involved in a MIMO transmission may be determined using a computation-based approach. For example, assuming a 2×2 MIMO transmission, an imbalanced MIMO.Pₗᵢₘᵢₜ₁ and imbalanced MIMO.Pₗᵢₘᵢₜ₂ may be determined via the computation-based approach such that the respective RF exposure hotspot at each antenna location is equal to an RF exposure design target. In certain aspects, the computation-based approach for determining the imbalanced MIMO Pₗᵢₘᵢₜₛ may be based on respective SISO Pₗᵢₘᵢₜₛ for the antennas and contribution factors indicating, for each antenna, an amount of RF exposure from each other antenna on the antenna.

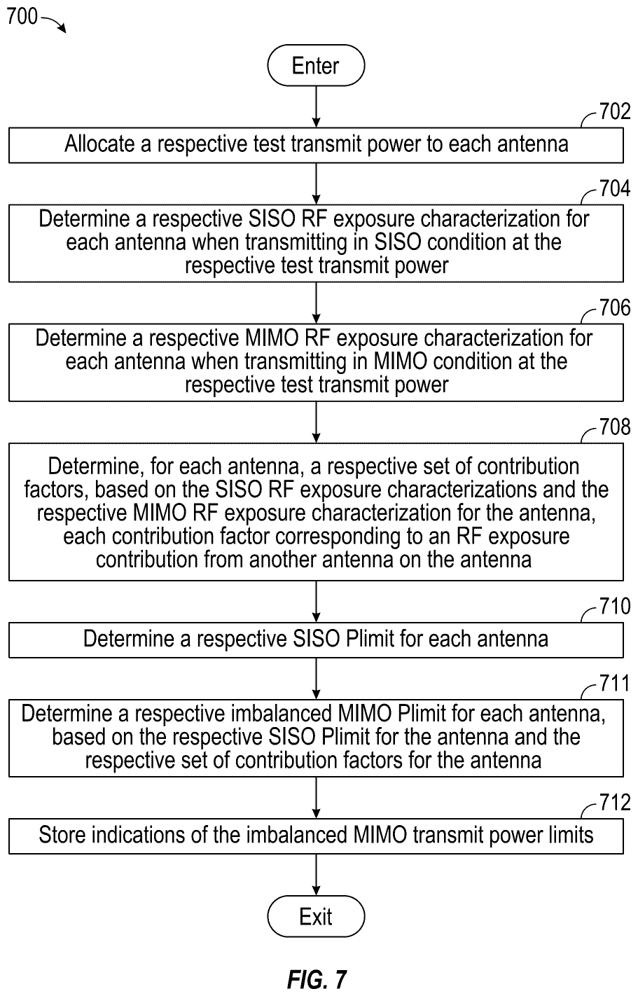

By way of example, FIG. 7 is a flow diagram illustrating example operations 700 for determining imbalanced MIMO Pₗᵢₘᵢₜₛ. The operations 700 may be performed, for example, by a processing system (e.g., processing system 402) and/or an RF exposure measurement system (e.g., RF exposure measurement system 400).

The operations 700 may optionally begin, at block 702, where the processing system may allocate a respective test transmit power to each antenna associated with a MIMO transmission. In certain aspects, each test transmit power that is allocated may be less than Pₘₐₓ. For example, for a 2×2 MIMO transmission, the processing system may allocate a test transmit power Pₜₑₛₜ₁ for antenna 1 and a test transmit power Pₜₑₛₜ₂ for antenna 2, such that Pₜₑₛₜ₁<Pₘₐₓ and Pₜₑₛₜ₂<Pₘₐₓ for both MIMO chains. Note, in certain cases, Pₜₑₛₜ₁ may be equal to Pₜₑₛₜ₂.

At block 704, the processing system may determine a respective SISO RF exposure characterization (e.g., RF exposure map or distribution) for each antenna when the antenna transmits in a SISO condition. Continuing with the aforementioned 2×2 MIMO transmission scenario, the processing system may measure SISO.RF.exposure1 for antenna 1 using Equation 20 and measure SISO.RF.exposure2 for antenna 2 using Equation 21:

$$maximum SISO . RF . exposure 1 = RFexposure 1 , when antenna 1 is transmitting in SISO condition at {P}_{test 1} \qquad ( 20 )$$

$$maximum SISO . RF . exposure 2 = RFexposure 2 , when antenna 2 is transmitting in SISO condition at {P}_{test 2} \qquad ( 21 )$$

At block 706, the processing system may determine a respective MIMO RF exposure characterization (e.g., RF exposure map or distribution) for each antenna when transmitting in MIMO condition at the respective test transmit power. Continuing with the aforementioned 2×2 MIMO transmission scenario, the processing system may measure MIMO.RF.exposure1 for antenna 1 using Equation 22 and measure MIMO.RF.exposure2 for antenna 2 using Equation 23:

$$maximum MIMO . RF . exposure 1 = combined . RFexposure 1 at location 1 closer to antenna 1 when transmitting in MIMO condition out of both antennas 1 \& 2 transmitting at “ {P}_{test 1} ” and “ {P}_{test 2} , ” respectively \qquad ( 22 )$$

$$maximum MIMO . RF . exposure 2 = combined . RFexposure 2 at location2 closer to antenna 2 when transmitting in MIMO condition out of both antennas 1 \& 2 transmitting at “ {P}_{test 1} ” and “ {P}_{test 2} , ” respectively \qquad ( 23 )$$

At block 708, the processing system may determine, for each antenna, a respective set of contribution factors, based on the SISO RF exposure characterizations and the respective MIMO RF exposure characterization for the antenna, each contribution factor corresponding to an RF exposure contribution from another antenna on the antenna. Continuing with the aforementioned 2×2 MIMO transmission scenario, if MIMO.RF.exposure1 is different from MIMO.RF.exposure2, then (i) the combined.RFexposure1 at location 1=RFexposure1+c21*RFexposure2, where “c21” is a contribution factor of antenna 2 towards hotspot in location 1, and (ii) the combined.RFexpsure2 at location 2=RFexposure2+c12*RFexposur1, where “c12” is a contribution factor of antenna 1 towards hotspot in location 2. Here, c21=max {(combined.RFexposure1−RFexposure1)/RFexposure2, 0}, and c12=max {(combined.RFexposure2−Rfexposure2)/RFexposure1, 0}.

At block 710, the processing system may determine a respective SISO Pₗᵢₘᵢₜ for each antenna. Each respective SISO Pₗᵢₘᵢₜ may be determined based on the respective test transmit power for the antenna and the measured SISO RF exposure characterization for the antenna. For example, continuing with the aforementioned 2×2 MIMO transmission scenario, the processing system may determine:

$$SISO . {P}_{limit 1} = {P}_{test 1} * RF exposure design target / RFexposure 1 where RFexposure 1 = ( {P}_{test 1} / SISO . {P}_{limit 1} ) * RF exposure design target \qquad ( 24 )$$

$$SISO . {P}_{limit 2} = {P}_{test 2} * RF exposure design target / RFexposure 2 where RFexposure 2 = ( {P}_{test 2} / SISO . {P}_{limit 2} ) * RF exposure design target \qquad ( 25 )$$

At block 712, the processing system may determine a respective imbalanced MIMO Pₗᵢₘᵢₜ for each antenna, based on the respective SISO Pₗᵢₘᵢₜ for the antenna and the respective set of contribution factors for the antenna. Continuing with the aforementioned 2×2 MIMO transmission scenario, an imbal.MIMO.Pₗᵢₘᵢₜ₁ may be determined for antenna 1 and an imbal.MIMO.Pₗᵢₘᵢₜ₂ may be determined for antenna 2. When transmitting at an imbal.MIMO.Pₗᵢₘᵢₜ₁ transmission power out of antenna 1 and imbal.MIMO.Pₗᵢₘᵢₜ₂ transmission power out of antenna 2, the MIMO RF exposure hotspots at both locations 1 and 2 should correspond to the RF exposure design target.

Therefore, at location 1, the RF exposure may be expressed using the following:

$$\begin{matrix}RF exposure = RF exposure design target \\ = RF exposure from antenna 1 + \\ c 21 * RF exposure from antenna 2\end{matrix} \qquad ( 26 )$$

where RF exposure from antenna 1=(imbal.MIMO.Pₗᵢₘᵢₜ₁/SISO.Pₗᵢₘᵢₜ₁)*RF exposure design target and RF exposure from antenna 2=(imbal.MIMO.Pₗᵢₘᵢₜ₂/SISO.Pₗᵢₘᵢₜ₂)*RF exposure design target. Thus, the RF exposure at location 1 may be expressed as 1=a1+c21*a2, where a1=(imbal.MIMO.Pₗᵢₘᵢₜ₁/SISO.Pₗᵢₘᵢₜ₁) and a2=(imbal.MIMO.Pₗᵢₘᵢₜ₂/SISO.Pₗᵢₘᵢₜ₂). Similarly, at location 2, the RF exposure may be expressed using the following:

$$\begin{matrix}RF exposure = RF exposure design target \\ = RF exposure from antenna 1 + \\ c 12 * RF exposure from antenna 2\end{matrix} \qquad ( 27 )$$

Thus, the RF exposure at location 2 may be expressed as 1=a2+c12*a1.

From the RF exposure at location 1 (e.g., 1=a1+c21*a2) and the RF exposure at location 2 (e.g., 1=a2+c12*a1), a1 and a2 may be represented using the following:

$$a 1 = ( 1 - c 21 ) / ( 1 - c 12 * c 21 ) \qquad ( 28 )$$

$$a 2 = ( 1 - c 12 ) / ( 1 - c 12 * c 21 ) \qquad ( 29 )$$

Using the expressions in Equations 28 and 29, the imbal.MIMO.Pₗᵢₘᵢₜ₁ and imbal.MIMO.Pₗᵢₘᵢₜ₂ may be represented using the following:

$$imbal . MIMO . {P}_{limit 1} = SISO . {P}_{limit 1} * ( 1 - c 21 ) / ( 1 - c 12 * c 21 ) \qquad ( 30 )$$

$$imbal . MIMO . {P}_{limit 2} = SISO . {P}_{limit 2} * ( 1 - c 12 ) / ( 1 - c 12 * c 21 ) \qquad ( 31 )$$

At block 714, the processing system may store indications of the imbalanced MIMO transmit power limits. In some aspects, the imbalanced MIMO Pₗᵢₘᵢₜₛ may be in the form of a look-up table (or other data structure) including one or more values of the imbalanced MIMO Pₗᵢₘᵢₜ for each antenna depending on the transmit scenario. Such a look-up table may be stored in the memory of the wireless device, such as the memory 240. In some aspects, the look-up table (or data structure) may be converted and/or compressed to a computer-readable dataset format, such as SQLite, JSON, XML, or any other suitable dataset format. The look-up table (or data structure) may be generated by an RF exposure measurement system (e.g., RF exposure measurement system 400). In certain aspects, the look-up table (or data structure) may be generated as part of an RF exposure compliance certification procedure.

Note, for the aforementioned 2×2 MIMO transmission scenario, the determination of imbal.MIMO.Pₗᵢₘᵢₜ₁ and imbal.MIMO.Pₗᵢₘᵢₜ₂ using Equations 30 and 31 may assume that the 2×2 MIMO RF exposure distribution can be determined using SISO RF exposure distributions, SISO.RF.exposure1 and SISO.RF.exposure2. In particular, Equations 30 and 31 may assume the following:

$$MIMO . RF . exposure ( x , y , z ) = SISO . RF . exposure 1 ( x , y , z ) + SISO . RF . exposure 2 ( x , y , z ) + 2 * sqrt ( SISO . RF . exposure 1 ( x , y , z ) * SISO . RF . exposure 2 ( x , y , z ) \qquad ( 32 )$$

Additionally, Equations 30 and 31 may assume that, if the two antennas are spatially apart, then MIMO.RF.exposure (x,y,z) may have two exposure hotspots at locations 1 and 2 closer to each of the antenna feed points. As such, the MIMO.RF.exposure can be approximated at the location 1 (x1,y1,z1) hotspot closer to antenna 1 using the following:

$$max ( RFexposure 1 ) + c 21 * max ( RFexposure 2 ) \qquad ( 33 )$$

where c21 is the contribution factor of antenna 2 towards hotspot in location 1, max (RFexposure1) is the SISO RF exposure of antenna 1 at location 1, and max (RFexposure2) is the SISO RF exposure of antenna 2 at location 2. Here, it is assumed that c21 does not change as a function of max (RFexposure1) and max (RFexposure2) amplitudes.

Similarly, the MIMO.RF.exposure can be approximated at the location 2 (x2,y2,z2) hotspot closer to antenna 2 using the following:

$$max ( RFexposure 2 ) + c 12 * max ( RFexposure 1 ) \qquad ( 34 )$$

where c12 is the contribution factor of antenna 1 towards hotspot in location 2. Here, it is assumed that c12 does not change as a function of max (RFexposure1) and max (RFexposure2) amplitudes.

In an illustrative 2×2 MIMO transmission scenario, assume that the RF exposure design target=1.0 W/kg for a 1gSAR design target. In this scenario, the operations in blocks 704 and 706 may involve, determining that, when transmitting at Pₜₑₛₜ₁=Pₜₑₛₜ₂=17 dBm, the measured SISO.RF.exposure1=1.0 w/kg (e.g., Equation 20), the measured SISO.RF.exposure2=0.5 W/kg (e.g., Equation 21), the measured MIMO.RF.exposure1=1.2 W/kg (e.g., Equation 22), and the measured MIMO.RF.exposure2=0.6 W/kg (e.g., Equation 23).

Continuing with the aforementioned 2×2 MIMO transmission scenario, the operations in block 708 may involve determining that c21=0.4 and c12=0.1. Additionally, the operations in block 710 may involve determining that SISO.Pₗᵢₘᵢₜ₁=17 dBm (or 50 mW) (e.g., Equation 24) and SISO.Pₗᵢₘᵢₜ₂=20 dBm (or 100 mW) (e.g., Equation 25). Based on the foregoing, the operations in block 712 may involve determining imbal.MIMO.Pₗᵢₘᵢₜ₁=14.95 dBm (or 31.75 mW) (e.g., Equation 30) and imbal.MIMO.Pₗᵢₘᵢₜ₂=19.72 dBm (or 93.75 mW) (e.g., Equation 31). Thus, for this aforementioned 2×2 MIMO transmission scenario, the total imbalance.MIMO.Pₗᵢₘᵢₜ power from both chains=14.95 dBm (31.75 mW)+19.72 dBm (93.75 mW)=21 dBm, resulting in a 1.0 W/kg for both hotspots, whereas the total balanced.MIMO.Pₗᵢₘᵢₜ power from both chains=3 dBm+16.2 dBm resulting in RF exposure of 1.0 W/kg at hotspot for location 1 and 0.5 W/kg at hotspot for location 2.

Note that while many aspects described herein use a 2×2 MIMO transmission scenario as an illustrative MIMO transmission scenario in which the techniques described herein for determining imbalanced MIMO transmission power limits can be implemented, the techniques described herein can be implemented for other MIMO transmission scenarios. For example, in certain aspects, the techniques described herein can be implemented for a N×N MIMO transmission scenario with N antennas. In such aspects, the operations 700 in FIG. 7 may be performed to determine an imbal.MIMO.Pₗᵢₘᵢₜ₁, imbal.MIMO.Pₗᵢₘᵢₜ₂, . . . , imbal.MIMO.P_{limitN} for a N×N MIMO system of antennas, such that RF exposure hotspots at all N antenna location is equal to an RF exposure design target.

In such an N×N MIMO system, the operations in block 704 may involve determining the respective SISO RF exposure characterization for each antenna using the following:

$$maximum SISO . RF . exposure ( i ) = RFexposure ( i ) , when antenna i is transmitting in SISO condition at {P}_{test} \qquad ( 35 )$$

The operations in block 706 may involve determining the respective MIMO RF exposure characterization for each antenna using the following:

$$maximum MIMO . RF . exposure ( i ) = combined . RFE ( i ) at location ( i ) closer to antenna ( i ) when transmitting in NxN MIMO condition out of all N antennas transmitting at {P}_{test} \qquad ( 36 )$$

Since the maximum MIMO RF exposure value at location (i) is due to contributions from all transmitting antennas with self-contribution of antenna (i)=1, then at location (i), the combined.RFexposure (i) may be represented using the following:

$$combined . RFexposure ( i ) = {\sum }_{j = 1}^{N} \{ c ( j , i ) * RFexposure ( j ) \} \qquad ( 37 )$$

where “c(j,i)” is the contribution factor of antenna (j) towards hotspot in location (i) and c(i,i)=1. For an N×N MIMO system, Equation 37 may result in N equations. However, there may be (N²−N)=N*(N−1) unknowns since c (j≠i, i). Therefore, pair wise antennas (i,j) can be excited at Pₜₑₛₜ to measure MIMO RF exposure at locations (i) and (j) to determine c(i,j) and c(j,i), while all remaining antennas are set to 0 transmit power (e.g., turn OFF other antennas) resulting in a total of N²/2 measurements (e.g., divide by “2” because (i,j) excitation may be identical to (j, i) excitation. Here, it is assumed that turning OFF other antennas does not have significant influence in changing contribution factors [c(i,j)] matrix. Accordingly, for a given antenna pair (i,j) MIMO measurement, the operations in block 708 may involve determining c(j, i) based on Equation 38 and determining c(i, j) based on Equation 39:

$$c ( j , i ) = max \{ ( combined . RFexposure ( i ) - RFexposure ( i ) ) / RFexposure ( j ) , 0 \} \qquad ( 38 )$$

$$c ( i , j ) = max \{ ( combined . RFexposure ( j ) - RFexposure ( j ) ) / RFexposure ( i ) , 0 \} \qquad ( 39 )$$

Using Equations 38 and 39, the operations in block 712 may involve solving N equations of the following representation to determine the respective imbal.MIMO.Pₗᵢₘᵢₜ₍ᵢ₎ for antenna (i):

$$Equation ( i )$$

$$1 = {\sum }_{j = 1}^{N} \{ c ( j , i ) * a ( j ) \} , where a ( j ) = ( imbal . MIMO . {P}_{limit ( j )} / SISO . {P}_{limit ( j )} ) \qquad ( 40 )$$

Accordingly, for an N×N MIMO transmission, when transmitting simultaneously at imbal.MIMO.Pₗᵢₘᵢₜ₍ᵢ₎ transmission power out of each antenna (i), the MIMO RF exposure hotspots at all locations(i) should correspond to the RF exposure design target.

Additionally, certain aspects provide techniques for performing a MIMO transmission with multiple antennas, based at least in part on the imbalanced MIMO Pₗᵢₘᵢₜₛ. Referring back to FIG. 5, assuming a 2×2 MIMO transmission with imbal.MIMO.Pₗᵢₘᵢₜ₁ and imbal.MIMO.Pₗᵢₘᵢₜ₂, the operations at block 506 may involve determining the total NE at each time interval using the following:

$$total . NE ( t ) = {\sum }_{( i , j ) = 1}^{m} max \{ \frac{{Tx}_{i} ( t )}{imbal . MIMO . {P}_{limit i}} , \frac{{Tx}_{j} ( t )}{imbal . MIMO . {P}_{limit j}} \} \qquad ( 41 )$$

Assuming a MIMO transmission with “n” SISO transmitters and “m” MIMO transmitters, the operations at block 506 may involve determining the total NE at each time interval using the following:

$$time . avg . NE = \frac{1}{T} {\int }_{t - T}^{T} [ {\sum }_{k = 1}^{n} \frac{{Tx}_{k} ( t )}{{P}_{limitk}} + {\sum }_{( i , j ) = 1}^{m} max \{ \frac{{Tx}_{i} ( t )}{imbal . MIMO . {P}_{limit i}} , \frac{{Tx}_{j} ( t )}{imbal . MIMO . {P}_{limit j}} \} ] dt \leq 1 \qquad ( 42 )$$

Additionally, assuming a 2×2 MIMO transmission with imbal.MIMO.Pₗᵢₘᵢₜ₁ and imbal.MIMO.Pₗᵢₘᵢₜ₂, the operations at block 510 may involve distributing the available total NE(t+Δt) for a future time interval Δt. If there is a single active MIMO transmission, then the available total NE may not be split among active transmitters (e.g., r=1). Otherwise, the available total NE may be split among active transmitters. In such cases, when using imbalance MIMO Pₗᵢₘᵢₜₛ, the distribution may result in a different Pₘₐₓ on both antennas that is sent to each RF chain. For example, the Pₘₐₓ for antenna 1 may be represented using Equation 43 and the Pₘₐₓ for antenna 2 may be represented using Equation 44:

$$i mbal . MIMO . {Pmax}_{1} ( t + Δ t ) = r * available . total . NE ( t ) * imbal . MIMO . {P}_{limit 1} \qquad ( 43 )$$

$$i mbal . MIMO . {Pmax}_{2} ( t + Δ t ) = r * available . total . NE ( t ) * imbal . MIMO . {P}_{limit 2} \qquad ( 44 )$$

### Example Operations for Wireless Communications

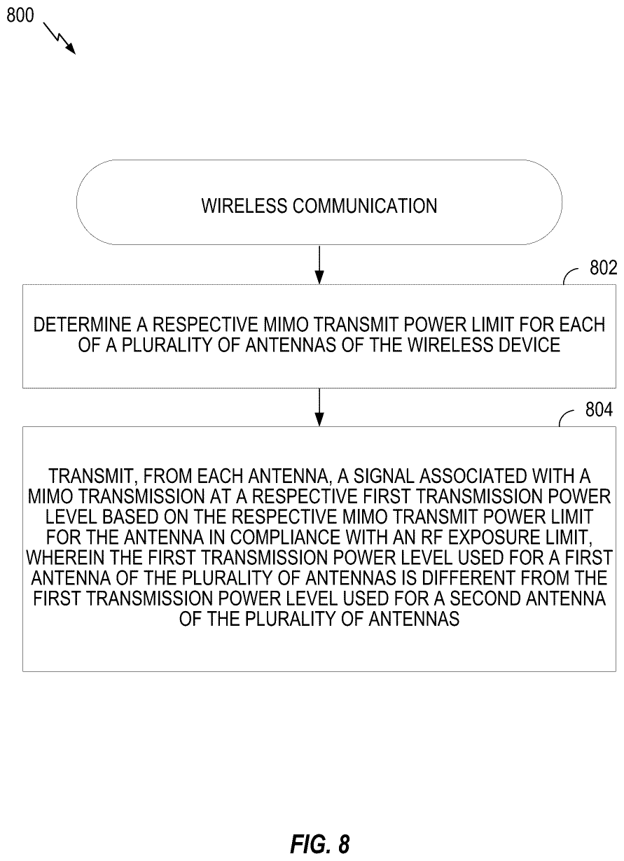

FIG. 8 is a flow diagram illustrating example operations 800 for wireless communication. The operations 800 may be performed, for example, by a wireless device (e.g., the wireless device 102 in the wireless communication system 100) and/or a processing system. The operations 800 may be implemented as software components that are executed and run on one or more processors (e.g., the processor 210 and/or the modem 212 of FIG. 2).

The operations 800 may involve, at block 802, determining a respective MIMO transmit power limit (e.g., imbal.MIMO.Pₗᵢₘᵢₜ₍ᵢ₎) for each of a plurality of antennas of the wireless device.

The operations 800 may also involve, at block 804, transmitting, from each antenna, a signal associated with a MIMO transmission at a respective first transmission power level based on the respective MIMO transmit power limit for the antenna in compliance with an RF exposure limit. The first transmission power level used for a first antenna of the plurality of antennas may be different from the first transmission power level used for a second antenna of the plurality of antennas.

In certain aspects, determining the MIMO transmit power limits may include: (i) accessing stored indications of the MIMO transmit power limits; and (ii) using the stored indications of the MIMO transmit power limits to generate the first transmission power levels.

In certain aspects, the RF exposure limit is a time-averaged RF exposure limit for a time window, and the signal may be transmitted during a first time interval within the time window. In such aspects, the operations 800 may further involve: (i) determining an exposure margin allowed for a second time interval, subsequent to the first time interval, based at least in part on the first transmission power levels and the MIMO transmit power limits; and (ii) allocating a respective second transmission power level to each of the plurality of antennas for the second time interval, based at least in part on the exposure margin allowed for the second time interval and the MIMO transmit power limits. The second transmission power level for the first antenna of the plurality of antennas may be different from the second transmission power level for the second antenna of the plurality of antennas.

In certain aspects, the MIMO transmit power limit for the first antenna of the plurality of antennas may be different from the MIMO transmit power limit for the second antenna of the plurality of antennas.

In certain aspects, a respective RF exposure level for each of the plurality of antennas for the MIMO transmission may be equal to an RF exposure design target for the wireless device.

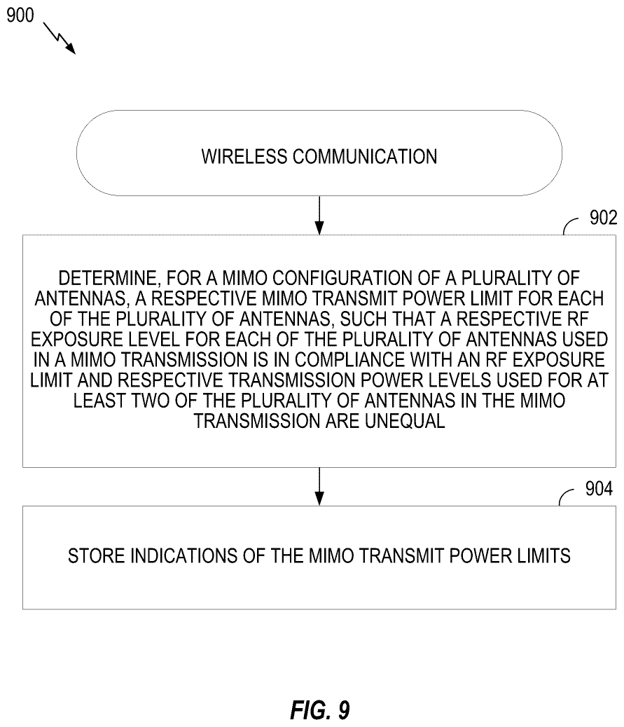

FIG. 9 is a flow diagram illustrating example operations 800 for wireless communication. The operations 800 may be performed, for example, by a wireless device (e.g., the wireless device 102 in the wireless communication system 100), a processing system, and/or an RF exposure measurement system (e.g., RF exposure measurement system 400). The operations 800 may be implemented as software components that are executed and run on one or more processors (e.g., the processor 210 and/or the modem 212 of FIG. 2, processor 408 of FIG. 4, etc.).

The operations 900 may involve, at block 902, determining, for a MIMO configuration of a plurality of antennas, a respective MIMO transmit power limit (e.g., imbal.MIMO.Pₗᵢₘᵢₜ₍ᵢ₎) for each of the plurality of antennas, such that a respective RF exposure level for each of the plurality of antennas used in a MIMO transmission is in compliance with an RF exposure limit and respective transmission power levels used for at least two of the plurality of antennas in the MIMO transmission are unequal.

The operations 900 may also involve, at block 904, storing indications of the MIMO transmit power limits.

In certain aspects, determining the respective MIMO transmit power limit for each of the plurality of antennas may include: (i) allocating a respective test transmit power to each of the plurality of antennas; (ii) determining a respective RF exposure characterization for each antenna when each antenna transmits at the respective test transmit power as part of the MIMO transmission; (iii) iteratively adjusting at least one of the test transmit powers until the RF exposure characterizations satisfy a predetermined condition; and (iv) determining the MIMO transmit power limits for the plurality of antennas based on the respective test transmit powers having RF exposure characterizations that satisfy the predetermined condition. In some aspects, each of the test transmit powers may be less than a maximum transmit power for a wireless device. In some aspects, the predetermined condition includes the RF exposure characterization for each antenna being within a threshold difference to each other RF exposure characterization for each other antenna.

In certain aspects, determining the respective MIMO transmit power limit for each of the plurality of antennas may include: (i) determining a respective SISO transmit power limit for each of the plurality of antennas; (ii) determining, for each antenna, a respective one or more first contribution factors, each first contribution factor corresponding to an RF exposure contribution from another antenna of the plurality of antennas on the antenna; and (iii) determining the MIMO transmit power limit for each antenna based at least in part on the respective one or more first contribution factors for the antenna and the SISO transmit power limits. In some aspects, the respective SISO transmit power limit for each antenna of the plurality of antennas may be determined based at least in part on an RF exposure level of the antenna when the antenna is used in a SISO transmission. In some aspects, determining the respective MIMO transmit power limit for each of the plurality of antennas may further include determining, for each antenna, a respective one or more second contribution factors, each second contribution factor corresponding to an RF exposure contribution from the antenna on another antenna of the plurality of antennas. In such aspects, the MIMO transmit power limit for each antenna may be further based at least in part on the respective one or more second contribution factors for the antenna.

In certain aspects, the RF exposure limit includes an RF exposure design target. In such aspects, the respective MIMO transmit power limit for each of the plurality of antennas may be determined such that the respective RF exposure level for each of the plurality of antennas for the MIMO transmission is equal to the RF exposure design target.

In certain aspects, the MIMO transmit power limit for a first antenna of the plurality of antennas may be different from the MIMO transmit power limit for a second antenna of the plurality of antennas.

### Example Communications Device

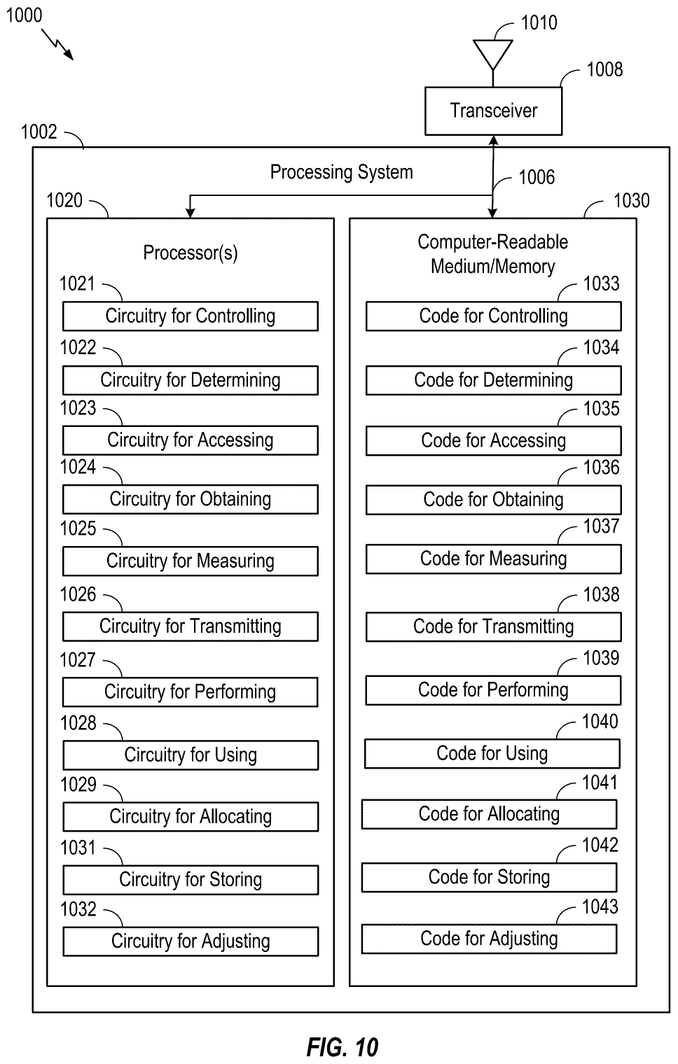

FIG. 10 depicts aspects of an example communications device 1000. In some aspects, communications device 1000 is a wireless communication device, such as the wireless device 102 described above with respect to FIGS. 1 and 2.

The communications device 1000 includes a processing system 1002 coupled to a transceiver 1008 (e.g., a transmitter and/or a receiver). The transceiver 1008 is configured to transmit and receive signals for the communications device 1000 via an antenna 1010, such as the various signals as described herein. The processing system 1002 may be configured to perform processing functions for the communications device 1000, including processing signals received and/or to be transmitted by the communications device 1000.

The processing system 1002 includes one or more processors 1020. In various aspects, the one or more processors 1020 may be representative of any of the processor 210 and/or the modem 212, as described with respect to FIG. 2. The one or more processors 1020 are coupled to a computer-readable medium/memory 1030 via a bus 1006. In certain aspects, the computer-readable medium/memory 1030 is configured to store instructions (e.g., computer-executable code) that when executed by the one or more processors 1020, cause the one or more processors 1020 to perform the operations 500 described with respect to FIG. 5, the operations 600 described with respect to FIG. 6, the operations 700 described with respect to FIG. 7, the operations 800 described with respect to FIG. 8, the operations 900 described with respect to FIG. 9, or any aspect related to the operations described herein. Note that reference to a processor performing a function of communications device 1000 may include one or more processors performing that function of communications device 1000.

In the depicted example, computer-readable medium/memory 1030 stores code (e.g., executable instructions) for controlling 1033 (including code for operating, code for refraining, and code for ceasing), code for determining 1034 (including code for detecting), code for accessing 1035, code for obtaining 1036, code for measuring 1037, code for transmitting 1038, code for performing 1039, code for using 1040, code for allocating 1041, code for storing 1042, and code for adjusting 1043 (collectively referred to herein as code 1033-1043). Processing of the code 1033-1043 may cause the communications device 1000 to perform the operations 500 described with respect to FIG. 5, the operations 600 described with respect to FIG. 6, the operations 700 described with respect to FIG. 7, the operations 800 described with respect to FIG. 8, the operations 900 described with respect to FIG. 9, or any aspect related to operations described herein.

The one or more processors 1020 include circuitry configured to implement (e.g., execute) the code stored in the computer-readable medium/memory 1030, including circuitry for controlling 1021 (including circuitry for operating, circuitry for ceasing, and circuitry for refraining), circuitry for determining 1022 (including circuitry for detecting), circuitry for accessing 1023, circuitry for obtaining 1024, circuitry for measuring 1025, circuitry for transmitting 1026, circuitry for performing 1027, circuitry for using 1028, circuitry for allocating 1029, circuitry for storing 1031, and circuitry for adjusting 1032 (collectively referred to herein as circuitry 1021-1032). Processing with circuitry 1021-1032 may cause the communications device 1000 to perform the operations 500 described with respect to FIG. 5, the operations 600 described with respect to FIG. 6, the operations 700 described with respect to FIG. 7, the operations 800 described with respect to FIG. 8, the operations 900 described with respect to FIG. 9, or any aspect related to operations described herein.

Various components of the communications device 1000 may provide means for performing the operations 500 described with respect to FIG. 5, the operations 600 described with respect to FIG. 6, the operations 700 described with respect to FIG. 7, the operations 800 described with respect to FIG. 8, the operations 900 described with respect to FIG. 9, or any aspect related to operations described herein. For example, means for transmitting, sending or outputting for transmission may include the TX path 214 and/or antenna(s) 218 of the wireless device 102 illustrated in FIG. 2 and/or transceiver 1008 and antenna 1010 of the communications device 1000 in FIG. 10. Means for receiving or obtaining may include the RX path 216 and/or antenna(s) 218 of the wireless device 102 illustrated in FIG. 2, and/or transceiver 1008 and antenna 1010 of the communications device 1000 in FIG. 10. Means for controlling, means for measuring, means for accessing, means for allocating, means for storing, means for adjusting, means for using, means for performing, means for operating, means for ceasing, means for refraining, means for determining, means for detecting, means for monitoring, means for comparing, means for obtaining, and/or means for providing may include a processor, such as the processor 210 and/or modem 212 depicted in FIG. 2 and/or the processor(s) 1020 in FIG. 10.

### Example Aspects

Implementation examples are described in the following numbered clauses:
Clause 1: A method for wireless communications by a wireless device, comprising: determining a respective multiple-input, multiple-output (MIMO) transmit power limit for each of a plurality of antennas of the wireless device; and transmitting, from each antenna, a signal associated with a MIMO transmission at a respective first transmission power level based on the respective MIMO transmit power limit for the antenna in compliance with a radio frequency (RF) exposure limit, wherein the first transmission power level used for a first antenna of the plurality of antennas is different from the first transmission power level used for a second antenna of the plurality of antennas.
Clause 2: The method of Clause 1, wherein determining the MIMO transmit power limits comprises: accessing stored indications of the MIMO transmit power limits; and using the stored indications of the MIMO transmit power limits to generate the first transmission power levels.
Clause 3: The method according to any of Clauses 1-2, wherein the RF exposure limit is a time-averaged RF exposure limit for a time window.
Clause 4: The method of Clause 3, wherein the signal is transmitted during a first time interval within the time window, the method further comprising: determining an exposure margin allowed for a second time interval, subsequent to the first time interval, based at least in part on the first transmission power levels and the MIMO transmit power limits; and allocating a respective second transmission power level to each of the plurality of antennas for the second time interval, based at least in part on the exposure margin allowed for the second time interval and the MIMO transmit power limits.
Clause 5: The method of Clause 4, wherein the second transmission power level for the first antenna of the plurality of antennas is different from the second transmission power level for the second antenna of the plurality of antennas.
Clause 6: The method according to any of Clauses 1-5, wherein the MIMO transmit power limit for the first antenna of the plurality of antennas is different from the MIMO transmit power limit for the second antenna of the plurality of antennas.
Clause 7: The method according to any of Clauses 1-6, wherein a respective RF exposure level for each of the plurality of antennas for the MIMO transmission is equal to an RF exposure design target for the wireless device.
Clause 8: A method for wireless communications, comprising: determining, for a multiple-input, multiple-output (MIMO) configuration of a plurality of antennas, a respective MIMO transmit power limit for each of the plurality of antennas, such that a respective radio frequency (RF) exposure level for each of the plurality of antennas used in a MIMO transmission is in compliance with a radio frequency (RF) exposure limit and respective transmission power levels used for at least two of the plurality of antennas in the MIMO transmission are unequal; and storing indications of the MIMO transmit power limits.
Clause 9: The method of Clause 8, wherein determining the respective MIMO transmit power limit for each of the plurality of antennas comprises: allocating a respective test transmit power to each of the plurality of antennas; determining a respective RF exposure characterization for each antenna when each antenna transmits at the respective test transmit power as part of the MIMO transmission; iteratively adjusting at least one of the test transmit powers until the RF exposure characterizations satisfy a predetermined condition; and determining the MIMO transmit power limits for the plurality of antennas based on the respective test transmit powers having RF exposure characterizations that satisfy the predetermined condition.
Clause 10: The method of Clause 9, wherein each of the test transmit powers is less than a maximum transmit power for a wireless device.
Clause 11: The method according to any of Clauses 9-10, wherein the predetermined condition comprises the RF exposure characterization for each antenna being within a threshold difference to each other RF exposure characterization for each other antenna.
Clause 12: The method of Clause 8, wherein determining the respective MIMO transmit power limit for each of the plurality of antennas comprises: determining a respective single-input, single-output (SISO) transmit power limit for each of the plurality of antennas; determining, for each antenna, a respective one or more first contribution factors, each first contribution factor corresponding to an RF exposure contribution from another antenna of the plurality of antennas on the antenna; and determining the MIMO transmit power limit for each antenna based at least in part on the respective one or more first contribution factors for the antenna and the SISO transmit power limits.
Clause 13: The method of Clause 12, wherein the respective SISO transmit power limit for each antenna of the plurality of antennas is determined based at least in part on an RF exposure level of the antenna when the antenna is used in a SISO transmission.
Clause 14: The method according to any of Clauses 12-13, wherein: determining the respective MIMO transmit power limit for each of the plurality of antennas further comprises determining, for each antenna, a respective one or more second contribution factors, each second contribution factor corresponding to an RF exposure contribution from the antenna on another antenna of the plurality of antennas; and the MIMO transmit power limit for each antenna is further based at least in part on the respective one or more second contribution factors for the antenna.
Clause 15: The method according to any of Clauses 8-14, wherein: the RF exposure limit comprises an RF exposure design target; and the determining comprises determining the respective MIMO transmit power limit for each of the plurality of antennas, such that the respective RF exposure level for each of the plurality of antennas for the MIMO transmission is equal to the RF exposure design target.
Clause 16: The method according to any of Clauses 8-15, wherein the MIMO transmit power limit for a first antenna of the plurality of antennas is different from the MIMO transmit power limit for a second antenna of the plurality of antennas.
Clause 17: An apparatus comprising: one or more memories collectively storing computer-executable instructions, and one or more processors coupled to the one or more memories, the one or more processors being collectively configured to execute the computer-executable instructions to cause the apparatus to perform a method in accordance with any of Clauses 1-7.
Clause 18: An apparatus for wireless communication, comprising means for performing a method in accordance with any of Clauses 1-7.
Clause 19: A non-transitory computer-readable medium comprising computer-executable instructions that, when collectively executed by one or more processors of a processing system, cause the processing system to perform a method in accordance with any of Clauses 1-7.
Clause 20: A computer program product embodied on a computer-readable storage medium comprising code for performing a method in accordance with any of Clauses 1-7.
Clause 21: An apparatus comprising: one or more memories collectively storing computer-executable instructions, and one or more processors coupled to the one or more memories, the one or more processors being collectively configured to execute the computer-executable instructions to cause the apparatus to perform a method in accordance with any of Clauses 8-16.
Clause 22: An apparatus for wireless communication, comprising means for performing a method in accordance with any of Clauses 8-16.
Clause 23: A non-transitory computer-readable medium comprising computer-executable instructions that, when collectively executed by one or more processors of a processing system, cause the processing system to perform a method in accordance with any of Clauses 8-16.
Clause 24: A computer program product embodied on a computer-readable storage medium comprising code for performing a method in accordance with any of Clauses 8-16.

### ADDITIONAL CONSIDERATIONS

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, “a processor,” “at least one processor,” or “one or more processors” generally refer to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory,” or “one or more memories” generally refer to a single memory configured to store data and/or instructions or multiple memories configured to collectively store data and/or instructions.

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, identifying, searching, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. A hardware module may include several electrical elements (e.g., one or more dies and/or other components) packaged together.

The various illustrative logical blocks, modules and circuits described in connection with the present disclosure may be implemented or performed with a general purpose processor, a digital signal processor (DSP), a neural network processor, a system on chip (SoC), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the physical (PHY) layer. In the case of a UE (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer-readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (random access memory), flash memory, ROM (read-only memory), PROM (programmable read-only memory), EPROM (erasable programmable read-only memory), EEPROM (electrically erasable programmable read-only memory), registers, magnetic disks, optical disks, hard drives, or any other suitable non-transitory storage medium, or any combination thereof. The machine-readable media may be embodied in a computer program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein (e.g., instructions for performing the operations described herein and illustrated in FIGS. 5-9).

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, or other physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

1. A method for wireless communications by a wireless device, comprising:
determining a respective multiple-input, multiple-output (MIMO) transmit power limit for each of a plurality of antennas of the wireless device; and
transmitting, from each antenna, a signal associated with a MIMO transmission at a respective first transmission power level based on the respective MIMO transmit power limit for the antenna in compliance with a radio frequency (RF) exposure limit, wherein the first transmission power level used for a first antenna of the plurality of antennas is different from the first transmission power level used for a second antenna of the plurality of antennas.

2. The method of claim 1, wherein determining the MIMO transmit power limits comprises:
accessing stored indications of the MIMO transmit power limits; and
using the stored indications of the MIMO transmit power limits to generate the first transmission power levels.

3. The method of claim 1, wherein the RF exposure limit is a time-averaged RF exposure limit for a time window.

4. The method of claim 3, wherein the signal is transmitted during a first time interval within the time window, the method further comprising:
determining an exposure margin allowed for a second time interval, subsequent to the first time interval, based at least in part on the first transmission power levels and the MIMO transmit power limits; and
allocating a respective second transmission power level to each of the plurality of antennas for the second time interval, based at least in part on the exposure margin allowed for the second time interval and the MIMO transmit power limits.

5. The method of claim 4, wherein the second transmission power level for the first antenna of the plurality of antennas is different from the second transmission power level for the second antenna of the plurality of antennas.

6. The method of claim 1, wherein the MIMO transmit power limit for the first antenna of the plurality of antennas is different from the MIMO transmit power limit for the second antenna of the plurality of antennas.

7. The method of claim 1, wherein a respective RF exposure level for each of the plurality of antennas for the MIMO transmission is equal to an RF exposure design target for the wireless device.

8. A method for wireless communications, comprising:
determining, for a multiple-input, multiple-output (MIMO) configuration of a plurality of antennas, a respective MIMO transmit power limit for each of the plurality of antennas, such that a respective radio frequency (RF) exposure level for each of the plurality of antennas used in a MIMO transmission is in compliance with a radio frequency (RF) exposure limit and respective transmission power levels used for at least two of the plurality of antennas in the MIMO transmission are unequal; and
storing indications of the MIMO transmit power limits.

9. The method of claim 8, wherein determining the respective MIMO transmit power limit for each of the plurality of antennas comprises:
allocating a respective test transmit power to each of the plurality of antennas;
determining a respective RF exposure characterization for each antenna when each antenna transmits at the respective test transmit power as part of the MIMO transmission;
iteratively adjusting at least one of the test transmit powers until the RF exposure characterizations satisfy a predetermined condition; and
determining the MIMO transmit power limits for the plurality of antennas based on the respective test transmit powers having RF exposure characterizations that satisfy the predetermined condition.

10. The method of claim 9, wherein each of the test transmit powers is less than a maximum transmit power for a wireless device.

11. The method of claim 9, wherein the predetermined condition comprises the RF exposure characterization for each antenna being within a threshold difference to each other RF exposure characterization for each other antenna.

12. The method of claim 8, wherein determining the respective MIMO transmit power limit for each of the plurality of antennas comprises:
determining a respective single-input, single-output (SISO) transmit power limit for each of the plurality of antennas;
determining, for each antenna, a respective one or more first contribution factors, each first contribution factor corresponding to an RF exposure contribution from another antenna of the plurality of antennas on the antenna; and
determining the MIMO transmit power limit for each antenna based at least in part on the respective one or more first contribution factors for the antenna and the SISO transmit power limits.

13. The method of claim 12, wherein the respective SISO transmit power limit for each antenna of the plurality of antennas is determined based at least in part on an RF exposure level of the antenna when the antenna is used in a SISO transmission.

14. The method of claim 12, wherein:
determining the respective MIMO transmit power limit for each of the plurality of antennas further comprises determining, for each antenna, a respective one or more second contribution factors, each second contribution factor corresponding to an RF exposure contribution from the antenna on another antenna of the plurality of antennas; and
the MIMO transmit power limit for each antenna is further based at least in part on the respective one or more second contribution factors for the antenna.

15. The method of claim 8, wherein:
the RF exposure limit comprises an RF exposure design target; and
the determining comprises determining the respective MIMO transmit power limit for each of the plurality of antennas, such that the respective RF exposure level for each of the plurality of antennas for the MIMO transmission is equal to the RF exposure design target.

16. The method of claim 8, wherein the MIMO transmit power limit for a first antenna of the plurality of antennas is different from the MIMO transmit power limit for a second antenna of the plurality of antennas.

17. An apparatus for wireless communication, comprising:
one or more memories collectively storing computer-executable instructions; and
one or more processors coupled to the one or more memories, the one or more processors being collectively configured to execute the computer-executable instructions to cause the apparatus to perform an operation comprising:
determining a respective multiple-input, multiple-output (MIMO) transmit power limit for each of a plurality of antennas of the apparatus; and
transmitting, from each antenna, a signal associated with a MIMO transmission at a respective first transmission power level based on the respective MIMO transmit power limit for the antenna in compliance with a radio frequency (RF) exposure limit, wherein the first transmission power level used for a first antenna of the plurality of antennas is different from the first transmission power level used for a second antenna of the plurality of antennas.

18. The apparatus of claim 17, wherein the signal is transmitted during a first time interval within the time window, the operation further comprising:
determining an exposure margin allowed for a second time interval, subsequent to the first time interval, based at least in part on the first transmission power levels and the MIMO transmit power limits; and
allocating a respective second transmission power level to each of the plurality of antennas for the second time interval, based at least in part on the exposure margin allowed for the second time interval and the MIMO transmit power limits.

19. The apparatus of claim 18, wherein the second transmission power level for the first antenna of the plurality of antennas is different from the second transmission power level for the second antenna of the plurality of antennas.

20. The apparatus of claim 17, wherein a respective RF exposure level for each of the plurality of antennas for the MIMO transmission is equal to an RF exposure design target for the wireless device.
